(19) United States
(12) Patent Application Publication
(10) Pub. No.: US 2017/0172167 A1
(43) Pub. Date: Jun. 22, 2017

(54) INFANT FEED AND METHOD

(71) Applicant: MEDELA HOLDING AG, Baar (CH)

(72) Inventors: Brian Silver, Woodstock, IL (US); Leon Mitoulas, Stirling (AU)

(73) Assignee: MEDELA HOLDING AG, Baar (CH)

(21) Appl. No.: 15/369,411

(22) Filed: Dec. 5, 2016

Related U.S. Application Data
(63) Continuation-in-part of application No. 15/217,561, filed on Jul. 22, 2016, now abandoned.
(60) Provisional application No. 62/196,098, filed on Jul. 23, 2015.
(60) Provisional application No. 62/196,104, filed on Jul. 23, 2015.
(60) Provisional application No. 62/196,116, filed on Jul. 23, 2015.

(30) Foreign Application Priority Data
Dec. 8, 2015 (AU) 2015268587

(51) Int. Cl. A23C 9/20; A23L 33/15; A23L 33/10; A23L 33/00

(52) U.S. Cl. CPC A23C 9/206; A23L 33/40; A23L 33/15; A23L 33/10; A23V 2002/00

(57) ABSTRACT

The present disclosure relates generally to a composition for feeding an infant. More particularly, the disclosure relates to a nutritional composition for feeding an infant comprising a stem-cell deficient first component and a second component comprising breast milk stem cells (BSCs). The second component is added to the first component, and the BSCs partially or fully replenish the stem-cell deficient first component with respect to BSCs. In some embodiments the first component is stem-cell deficient human breast milk and the second component comprises BSCs from the infant's mother's own milk. The compositions of the present disclosure have been developed primarily as a personalized, nutritional composition providing the beneficial effects of an infant's mother's own BSCs to the infant while not being able to receive the full benefits of being breastfed directly.

The present disclosure also relates to a composition for feeding an infant and to processes of their production. In particular, the disclosure relates to a composition for feeding an infant comprising a first and a second component, wherein the first component provides the majority of the nutritional value to said composition, and wherein the second component comprises at least one live bacterium from human breast milk or the lactating human mammary gland. The disclosure has been developed primarily as a composition for feeding a mother's own infant, wherein the composition comprises processed human breast milk with a substantially reduced live bacterial cell count as compared to unprocessed breast milk but which at least one live bacterium, from the mother's own breast milk, is added such as to partially or fully replenish the processed human breast milk with respect to the at least one live bacterium. More particular, the composition is a personalised composition for feeding the mother's own preterm infant.

The present invention also related to the combination of BSC and bacterial replenishment as described herein.

### CROSS-REFERENCE TO RELATED APPLICATIONS

This application is a continuation-in-part of U.S. patent application Ser. No. 15/217,561 filed Jul. 22, 2016, which claims benefit of the filing dates of U.S. Provisional Patent Application No. 62/196,116, filed Jul. 23, 2015, entitled “CELLULAR AND BACTERIAL REPLENISHMENT,” U.S. Provisional Patent Application No. 62/196,104, filed Jul. 23, 2015, entitled “CELLULAR REPLENISHMENT,” and U.S. Provisional Patent Application No. 62/196,098, filed Jul. 23, 2015, entitled “BACTERIAL REPLENISHMENT,” the disclosures of which are hereby incorporated by reference in their entirety.

### FIELD OF THE DISCLOSURE

The present disclosure relates generally to a composition for feeding an infant.

### BACKGROUND

Any discussion of the background art throughout the specification should in no way be considered as an admission that such art is widely known or forms part of common general knowledge in the field.

Human breast milk is a very complex fluid. Breast milk is an excellent source of macro- and micro-nutrients that allows for the normal development of the human infant during the early stages of life (Lawrence and Lawrence, 1999, Pediatr Rev. 2011 July; 32(7):267-80). In addition to being nutritious, breast milk contains a plethora of bioactive components which confer short- and long-term benefits to the neonate (Lönnerdal, 2003, Am J Clin Nutr 77, 1537S-1543S; Le Huërou-Luron et al., 2010, Nutr Res Rev 23, 23-36; Savino et al., 2010, Eur J Clin Nutr. 64(9):972-7).

Evidence has been accumulating providing support for positive long-term effects associated with increased duration of breastfeeding, such as improved cognitive ability, enhanced mucosal and immune system development, and reduced incidence of inflammatory bowel disease, atopic disease, hypertension, type 2 diabetes and obesity later in life (Oddy et al., 1999 BMJ, 319(7213):815-9; Horta et al., 2007 Rev Saude Publica. 41(1):13-8 ; Kramer, 2010, Early Hum Dev 86, 729-32). Short-term benefits of breastfeeding have been studied more frequently, and are associated with self-regulation of energy intake (Dewey and Lönnerdal, 1986, Acta Paediatr Scand. 75(6):893-8; Taveras et al., 2004 Pediatrics. 114(5):e577-83. Epub 2004 Oct. 18), and reduced susceptibility to gastrointestinal and respiratory infections (Howie et al., 1990 BMJ 300, 11-6 ; César et al., 1999 BMJ 318, 1316-20; Kramer, 2010; Le Huërou-Luron et al., 2010). And, although protective effects of breastfeeding against infection have been observed both in developing and developed countries (Kramer, 2010), the underlying mechanisms through which they are conferred are still the subject of ongoing research. Whilst these benefits are most typically associated with term delivered infants there is considerable evidence to show that they are also valid for preterm infants. In fact, breast milk is considered the preferred feed for all infants, especially for at-risk infants such as premature, low birth weight and sick infants. In preterm infants, human milk has been shown to reduce the risk of necrotising enterocolitis, late onset sepsis, retinopathy of prematurity and other diseases associated with preterm infants.

It has long been shown that breast milk contains a mixture of different cell types such as, for example, epithelial cells (lactocytes). It would appear that these cells are sloughing off the basement membrane of the breast as a consequence of the pressure and shear forces associated with the continued filling and emptying of the breast and, as a result infiltrate the milk. It has also been indicated that lactocytes account for approximately 10-20% of the total cell population (varying significantly between individual breast milk samples). While it has long been thought that the majority of the remainder of cells found in human milk are immune cells (such as lymphocytes, macrophages, monocytes, natural killer cells, basophils, eosinophils, and neutrophils) more recent data suggests that human breast milk from healthy subjects only contains a small percentage of immune cells.

In addition to lactocytes and immune cells, it has been demonstrated that a stem cell population exists in human breast milk (human breast milk stem cells; hBSCs), which expresses an array of genes responsible for the regulation of pluripotency in embryonic stem cells (ESCs or ES cells) such as, for example, the genes for the transcription factors (TFs) Oct4, Sox2, Nanog and Klf4.

Propagation of hBSCs in 3D culture conditions resulted in the formation of spheroids with a dramatic up-regulation of ESC TFs. Furthermore, hBSCs were shown to differentiate in vitro into cell types from all three germ layers, yet they did not form tumors when injected into mice. It was also shown that hBSCs express cellular markers linked to the suppression of an immune response. It has therefore been speculated that breast milk could serve as a plentiful source for stem cells with ESC-like properties. As indicated above, it has long been known that breast milk contains a mixture of different cell types. However, a comprehensive analysis and characterisation of human milk identifying all different cell types found in breast milk has only recently commenced.

In some instances, mothers may not be able to produce their own milk in sufficient quantities to provide adequate nutrition to their infant. Alternatively, some mothers may be prevented from breastfeeding their infant for certain periods, for example due to physical absence or illness. To ensure sufficient nutritional supply to infants who are not able to receive full nutrition by way of being directly breastfed mother's own milk, supplementary feedings of previously-expressed and stored mother's own milk, of donor human breast milk or of infant formula are often provided.

While formula-based feed compositions provide for the required nutritional intake, they lack the bioactive components as well as cellular content of breast milk, which has been considered critical to confer short- and long-term benefits to the neonate provided by mother's own milk. Also, as indicated above, a mother's own milk having been expressed and stored after expression by, for example, refrigeration or freezing, will lose bioactive components. The addition of pre- and probiotics to standard infant formula with a view to improving microbial colonisation of the gastrointestinal tract of fed infants has been investigated in a number of studies. For example, a study by J P Langhendries et al. (J Pediatr Gastroenterol Nutr. 1995 August; 21(2): 177-81) addressed the differences in colonisation with bifidobacteria of breastfed infants, as compared to infants fed whey-adapted infant formula and standard infant formula. The authors report that infants fed whey-adapted infant formula had gastrointestinal colonisation with bifidobacteria similar to breast milk fed infants, and significantly higher colonisation than standard formula fed infants.

Other researchers have examined the use of probiotics to restore microbial balance in the intestine when neonatal intestinal microbiota does not develop properly. For example, Olmstead et al. attempted to create an intestinal microbiota in formula fed infants, using probiotics, that more closely resembles the intestinal microbiota of healthy breast fed infants. (S. Olmstead et al., Micrometabolic Imprinting in Infancy: Microflora, Probiotics, and Chronic Disease, Klaire Labs, Technical Summary pages 1-5, 2007).

Addition of pre- or probiotics to infant formula to prepare supplemented feed compositions has been based on generalised observations and has so far not adequately considered the specific needs of the individual infant.

Currently, in instances where a mother cannot produce enough of her own milk to adequately nourish her infant or neonate, pooled, pasteurised donor milk is regularly used as the nutritional feed for the infant.

Bacterial screening and pasteurisation of donor milk is considered best practice to eliminate potentially hazardous contaminants, and constitutes a requirement for donor milk samples to be processed, stored and distributed by most human breast milk banks. Generally, pasteurisation aims to remove all bacteria present in donated breast milk. For donor milk to be stored and distributed by a milk bank, no bacterial growth should be detected subsequent to pasteurisation (Hartmann et al., Early Hum Dev. 2007 October; 83(10):667-73; Landers & Updegrove, Breastfeed Med. 2010 June; 5(3):117-21). It will be appreciated that other cellular components of breast milk, such as immune cells, progenitor cells and/or stem cells will also be inactivated. Beyond cellular components, the pasteurisation process may impact the quantity or quality of other organic components.

Furthermore, it was recently shown in a mouse model that breast milk stem cells can be transferred from the milk to neonatal organs (Hassiotou and Hartmann. 2014, Adv Nutr, vol. 5:770-779; Hassiotou et al. 2015, submitted manuscript).

While many consider a bottle feed of a mother's own previously-expressed breast milk or of pasteurised human donor milk to be the best alternative to directly breastfeeding the mother's infant, it will be appreciated that even simply expressing and refrigerating the milk will lead to a deficiency of the milk with respect to stem cells.

In instances where a mother has to interrupt breastfeeding, but where the mother would prefer to continue to feed her own milk to her infant during the period of interruption, surplus breast milk is often expressed in the lead-up to the interruption period such as to prepare a stock of the mother's own milk. Generally, the stocked milk is frozen for storage. The aim is to replace as many missed breastfeeds with feeds of the previously-expressed and stocked mother's own milk and to continue breastfeeding after the period of interruption. However, it will be appreciated that the breast milk being fed in such instances is stem cell-deficient as well as being deficient with respect to many of its other bioactive components.

It has been well established that human breast milk is the source of hundreds of bacterial phylotypes transferred from mother's own milk to the infant's gastrointestinal tract via breastfeeding and exposure to such a wealth of bacterial phylotypes is considered to play a role in the protective effects of breastfeeding. Direct links of bacterial content of breast milk and protection of the breastfed infant against diarrheal and respiratory diseases as well as the risk of developing other diseases, such as diabetes or obesity have been suggested (Hunt K M, et al. PLoS ONE 2011;6:e21313., Sanz Y. Journal of Clinical Nutrition 2011; 94(Suppl 6):2000S-5S). Breast milk bacteria have been shown to modulate both natural and acquired immune responses and may therefore also be involved in the maturation of the infant immune system (Diaz-Ropero M P, et al. Journal of Applied Microbiology 2006; 102:337-43, Olivares M, et al. International Microbiology 2006; 9:47-52., Olivares M, Diaz et al. Nutrition 2007; 23:254-60).

The first descriptions of the bacterial diversity of breast milk in healthy women were based on the use of culture media and showed the predominance of staphylococci, streptococci, lactic acid bacteria, propionibacteria and closely related Gram-positive bacteria including new bacterial species, such as Streptococcus lactarius (Martin V, et al. International Journal of Systematic and Evolutionary Microbiology 2011; 61:1048-52; Martin R, et al. Journal of Pediatrics 2003; 143:754-8, Heikkila M P, Saris P E J. Journal of Applied Microbiology 2003; 95:471-8, Gavin A, Ostovar K. Journal of Food Protection 1977; 40:614-6., West P A, et al. Journal of Applied Bacteriology 1979; 46:269-77).

Further studies, including culture-based as well as non-culture based studies revealed a plethora of bacterial genera represented in human breast milk. Molecular techniques, including fructose-6-phosphate phosphoketolase (F6PPK) assays and 16-S rRNA sequences, are being utilised to assess the presence and biodiversity of the human breast milk microbiota, as discussed in Isolation of Bifidobacteria from Breast Milk and Assessment of the Bifidobacterial Population by PCR-Denaturing Gradient Gel Electrophoresis and Quantitative Real-Time PCR (R. Martin, et al. Appl Environ Microbiol. 2009 February; 75(4): 965-969). Techniques for determining quantity of human milk microbiota are known as well.

Although the roles that beneficial breast milk bacteria play in ensuring infant health are not completely understood, some investigators have suggested that prenatal and perinatal intervention with maternal probiotic supplementation could be an effective avenue in reducing certain disease risks in infants, for example see Rautava et al. Microbial contact during pregnancy, intestinal colonization and human disease (Nature Reviews Gastroenterology & Hepatology, 2012 October: 9: 565-576.

Notwithstanding, and as indicated above, the clear findings that beneficial effects on the breastfed infant result from the human breast milk microbiota, the factors influencing the composition of an individual mother's milk microbiota, as well as the roles that beneficial breast milk bacteria play in ensuring infant health, are far from being completely understood.).

In some instances, mothers of term infants with health issues or preterm infants may not be able to produce their own milk in sufficient quantities to provide adequate nutrition to their infant. To ensure sufficient nutritional supply to preterm infants, who are not able to receive full nutrition by way of being fed mother's own milk, supplementary feedings of donor human breast milk or infant formula are often provided.

While formula-based feed compositions provide for the required nutritional intake, they lack the bioactive components as well as cellular content of breast milk, which has been considered critical to confer short- and long-term benefits to the neonate provided by mother's own milk.

The addition of pre- and probiotics to standard infant formula with a view to improving microbial colonisation of the gastrointestinal tract of fed infants has been investigated in a number of studies. For example, a study by J P Langhendries et al. (J Pediatr Gastroenterol Nutr. 1995 August; 21(2): 177-81) addressed the differences in colonisation with bifidobacteria of breastfed infants, as compared to infants fed whey-adapted infant formula and standard infant formula. The authors report that infants fed whey-adapted infant formula had gastrointestinal colonisation with bifidobacteria similar to breast milk fed infants, and significantly higher colonisation than standard formula fed infants.

Other researchers have examined the use of probiotics to restore microbial balance in the intestine when neonatal intestinal microbiota does not develop properly. For example, Olmstead et al. attempted to create an intestinal microbiota in formula fed infants, using probiotics, that more closely resembles the intestinal microbiota of healthy breast fed infants. (S. Olmstead et al., Micrometabolic Imprinting in Infancy: Microflora, Probiotics, and Chronic Disease, Klaire Labs, Technical Summary pages 1-5, 2007).

However, addition of pre- or probiotics to infant formula to prepare supplemented feed compositions has been based on generalised observations and has so far not adequately considered the specific needs of the individual infant. In some instances, reconstituted doses of probiotics were administered to preterm infants, as once-daily supplements to the infant's regular feeds. The probiotic dose was typically reconstituted in small volumes of either sterile water, mother's own breastmilk or human donor breast milk and fed to the infants (Deshpande et al., Evidence-based guidelines for use of probiotics in preterm neonates, BMC Med. 2011; 9: 92; Patole et al. Effect of Bifidobacterium breve M-16V Supplementation on Fecal Bifidobacteria in Preterm Neonates—A Randomised Double Blind Placebo Controlled Trial. (2014) PLoS ONE 9(3): e89511. doi:10.1371/journal.pone.0089511)

The specific biological benefits of human breast milk are immensely important for neonates at risk, particularly for neonates in a neonatal intensive care unit (NICU). For example, the composition of the individual neonate's intestinal microbiota is an important risk factor for the development of disease in preterm infants. For example, the development of necrotising enterocolitis (NEC) has been linked to the differing intestinal microbiota of preterm infants (Westerbeek E A, et al. Clin Nutr 2006; 25:361-8.) and it has been speculated that this difference is likely due to multiple factors, including early and repeated exposure to antibiotics, immaturity of the intestinal innate immune system, prolonged hospital stays, differences in feeding regimens, and lack of time with and proximity to family members. Further the risk of developing NEC in premature infants increases with the number of days the infant receives empiric antibiotics. (Cotten C M, et al. Pediatrics 2009; 123:58-66; Alexander V N et al. J Pediatr 2011; 159:392-7; Kuppala V S, et al. J Pediatr 2011; 159:720-5). The observed decrease in the incidence of NEC in breastfed preterm infants has been linked with the presence of secretory IgA, specific macrophages and lymphocytes within breast milk as well as with the presence of beneficial, non-pathogenic bacteria and their secretory molecules with antimicrobial properties.

Currently, in instances where a mother cannot produce enough own milk to adequately nourish her infant or neonate, pooled, pasteurised donor milk is regularly used as the nutritional feed for the infant.

Homologous fortification of human milk has been suggested. (See, e.g., Valentini F S. “Homologous fortification of human milk for the preterm very low birth weight infant in developing countries.” PhD Thesis, The University of British Columbia, Canada, 1995.) Valentini suggested to fortify human milk with a human milk-derived fortifier in a similar fashion to how bovine derived fortifiers are used, i.e., concentrate mother's own milk and then add small volumes of the concentrate to a base volume of mother's own milk. A significant motivation for this was the setting in developing countries, which do not allow for the routine use of expensive bovine milk based fortifiers.

Bacterial screening and pasteurisation of donor milk is considered best practice to eliminate potentially hazardous contaminants, and constitutes a requirement for donor milk samples to be processed, stored and distributed by most human breast milk banks. Generally, pasteurisation aims to remove all bacteria present in donated breast milk. For donor milk to be stored and distributed by a milk bank, no bacterial growth should be detected subsequent to pasteurisation (Hartmann et al., Early Hum Dev. 2007 October; 83(10):667-73; Landers & Updegrove, Breastfeed Med. 2010 June; 5(3):117-21).

As will be appreciated from the above, and while many consider pasteurised human donor milk to be the best alternative to mother's own milk, processing of the donated milk also removes or inactivates many of the bioactive components present in mother's own milk considered critical to confer the above-mentioned short- and long-term benefits of breast milk to infants, such as neonates.

Accordingly, there is a need for infant feed compositions formulated to confer short- and long-term benefits of breast milk to the neonate.

### SUMMARY OF THE DISCLOSURE

### Milk-Based Foods and Methods of Preparing Them

In a first aspect, the present invention provides method of preparing a milk-based food for a human infant comprising:

(a) assaying a sample of a feed, the feed comprising human breast milk, to measure the quantity or activity of at least one non-cellular organic component(s);

(b) identifying a deficiency in the quantity or activity of at least one of the at least one non-cellular organic component(s) in the feed sample; and

(c) supplementing the feed with one or more of: (1) living cells that produce a non-cellular organic component identified as being deficient in (b); (2) a quantity of said non-cellular organic component in cell-free, biologically active form; and (3) unpasteurized, unfrozen human breast milk that contains (1) or (2), to reduce the deficiency identified in (b).

In one embodiment, the human breast milk of step (a) has been frozen and/or pasteurized prior to the assaying.

In a second aspect, the present invention provides a method of preparing a milk-based food for a human infant comprising:

(a) providing a feed that comprises pasteurized human breast milk;

(b) supplementing the feed with one or more of: (1) living cells that produce a non-cellular organic component of human breast milk that is destroyed or inactivated by pasteurization; (2) a quantity of said non-cellular organic component in cell-free, biologically active form; and (3) unpasteurized, unfrozen human breast milk that contains (1) or (2), to replace a deficiency in said component resulting from the pasteurization.

In another embodiment, the at least one non-cellular organic component contributes to the digestibility of the feed or the bioavailability of a nutrient component of the feed.

In another embodiment, the human breast milk in the feed of (a) comprises donor breast milk from a human female who is not the biological mother of the human infant.

In another embodiment, the at least one non-cellular organic component comprises an enzyme capable of digestion of a component of human breast milk, to improve absorption or bioavailability in a human infant.

In another embodiment, the enzyme is a lipase.

In another embodiment, the at least one non-cellular organic component comprises a vitamin transporting protein.

In another embodiment, the at least one vitamin transporting protein comprises haptocorrin.

In another embodiment, the at least one non-cellular organic component comprises an immunomodulatory protein.

In another embodiment, the immunomodulatory protein comprises a lactoferrin protein.

In another embodiment, the at least one non-cellular organic component used for the supplementing is purified and isolated from human breast milk.

In another embodiment, the at least one non-cellular organic component used for the supplementing is provided by unpasteurized, never-frozen human breast milk from the biological mother of the human infant.

In another embodiment, the at least one non-cellular organic component used for the supplementing is provided by concentrated unpasteurized, never-frozen human breast milk.

In another embodiment, the method further comprises adding breast milk stem cells (BSCs) to the feed.

In another embodiment, the method further comprises adding at least one live bacterium to the feed.

In another embodiment, the method further comprises feeding the supplemented feed to a human infant.

In another embodiment, the human infant is a pre-term infant.

In a third aspect, the present invention provides a milk-based food prepared according to the method of the first aspect or the second aspect.

### Devices

In a fourth aspect, the present invention provides an infant feeding device containing a milk-based food of the third aspect.

In a fifth aspect, the present invention provides a device comprising:

(1) a milk chamber for receiving human breast milk;

(2) at least one reagent chamber; and

(3) at least one reaction chamber for mixing a sample of the human breast milk with at least one reagent from the at least one reagent chamber.

In one embodiment, the device further comprises:

(4) a detector to provide a quantitative indication of at least one reaction product(s) from the sample of the human breast milk and the reagent.

In another embodiment, the device further comprises at least one supplement chamber to hold at least one nutritional supplement suitable for addition to human breast milk.

In another embodiment, the at least one reagent chamber contains reagent(s) for measuring the quantity and/or activity of at least one non-cellular organic component of human milk; and the at least one supplement chamber contain(s) at least one nutritional supplement that comprises said at least one non-cellular organic component measurable with the reagent(s).

In another embodiment, the device further comprises an infant feeding device operably connected to the at least one reagent chamber to receive a measured amount of nutritional supplement from the at least one supplement chamber.

In another embodiment, the infant feeding device comprises a bottle, a syringe, or an enteral pump.

### Breast Milk Stem Cell Compositions and Processes

The present disclosure relates generally to a composition for feeding an infant. More particularly, the disclosure relates to a nutritional composition for feeding an infant comprising a stem-cell deficient first component and a second component comprising breast milk stem cells (BSCs). The second component is added to the first component, and the BSCs partially or fully replenish the stem-cell deficient first component with respect to BSCs. In some embodiments the first component is stem-cell deficient human breast milk and the second component comprises BSCs from the infant's mother's own milk. The compositions of the present disclosure have been developed primarily as personalized, nutritional compositions providing the beneficial effects of an infant's mother's own BSCs to the infant while not being able to receive the full benefits of being breastfed directly, and will be described hereinafter with reference to this application. However, it will be appreciated that the disclosure is not limited to this particular field of use.

The present disclosure relates to the inclusion of BSCs in feeds for an infant, for example nutritional feeds, such as to confer the beneficial effects of the BSCs to the infant and, specifically, to support and/or enhance the healthy development of the infant. In certain embodiments the feeds serve are provided to an infant for the purpose of supporting and/or enhancing growth and development of the infant as opposed to being provided as a therapeutic to treat a disease or disorder. As such, it will be appreciated that the compositions of the present disclosure may be provided to an infant in a non-therapeutic setting.

It has been found that stem cells diminish in breast milk shortly after the milk has been expressed, despite the expressed milk being refrigerated immediately after expression. Therefore, even a mother's own, expressed and otherwise unprocessed breast milk will become stem cell deficient shortly after expression.

In another aspect the present disclosure relates to a personalised nutritional composition for feeding an infant comprising (a) a stem-cell deficient first component providing the majority of the nutritional value to the composition, and (b) a second component comprising breast milk stem cells (BSCs).

In some embodiments the BSCs have been isolated from said infant's mother's own milk and have subsequently been proliferated in culture. Typically, the BSCs have been proliferated in BSC spheroid culture.

In other embodiments, the second component is said mother's own milk, which has been concentrated. Typically said mother's own milk has been concentrated by ultrafiltration.

In some embodiments, the first component is human breast milk. Often said human breast milk of the first component has been processed. In some embodiments the human breast milk is from said mother, in alternative embodiments the human breast milk is not from said mother. Typically, the human breast milk of the first component has been processed for handling and/or storage. In some instances, the breast milk has been frozen. In other instances the human breast milk has been sterilised and/or, pasteurised. In some embodiments, the human breast milk of the first component is human donor breast milk.

Alternatively, the first component is infant formula.

Typically, the composition comprises the BSCs in an amount similar to or greater than the amount of BSCs found in a corresponding volume of said infant's mother's own unprocessed or fresh breast milk. Accordingly, the second component partially or fully replenishes or enhances said processed human breast milk with respect to BSCs depleted during processing.

In another aspect, the present invention relates to a personalised nutritional composition for feeding an infant, wherein said composition comprises human breast milk with a substantially reduced live BSC count as compared to unprocessed or fresh breast milk but to which BSCs from the infant's mother's own breast milk are added, such that said processed human breast milk is partially or fully replenished or enhanced with respect to BSCs.

Typically, the processed human breast milk is said mother's own pasteurised and/or previously-frozen milk. Alternatively, the processed human breast milk is pasteurised and/or previously-frozen human donor breast milk.

In another aspect, the present invention relates to a personalised nutritional composition for feeding an infant, said composition comprising:

(a) either breast milk stem cell-deficient human breast milk or infant formula as a first component, wherein said first component provides the majority of the nutritional value to the composition; and

(b) a second component comprising BSCs isolated from said infant's mother's own breast milk.

In another aspect, the present invention relates to a nutritional composition for feeding an at-risk infant selected from the group of preterm infants, low birth weight infants and sick infants, said composition comprising:

(a) a first breast milk stem cell-deficient component providing the majority of the nutritional value to the composition; and

(b) a second component comprising BSCs isolated from said infant's mother's own breast milk,

wherein said composition comprises said BSCs from said mother's breast milk in an amount similar to or greater than the amount of said BSCs found in a corresponding volume of said mother's own unprocessed or fresh breast milk.

In another aspect, the present invention relates to a process for preparing a personalised nutritional composition for feeding an infant, said process comprising the steps of

(a) isolating BSCs from said infant's mother's own breast milk;

(b) providing a first breast milk stem cell-deficient component, said first component providing the majority of the nutritional value to the composition;

(c) providing a second component comprising the BSCs isolated from said mother's own breast milk in step a); and

(d) adding said second component to said first component.

Typically, the process further comprises the step of:

(a₁) culturing said isolated BSCs under conditions conducive to the proliferation of said BSCs such that the amount of BSCs is increased prior to adding said BSCs to said second component.

In one embodiment, the culturing of step a₁) is culturing said BSCs in BSC spheroid culture.

In some embodiments the process further comprises the step of:

(e) maintaining said composition under conditions conducive to the preservation of said BSCs.

In some further embodiments the first component is breast milk stem cell-deficient human breast milk and said second component comprises a BSC population profile mirroring the BSC population profile of said mother's own unprocessed or fresh breast milk. Typically, the composition comprises said BSCs in an amount similar to or greater than the amount of said BSCs in a corresponding volume of said mother's own unprocessed or fresh breast milk such that adding said second component to said first component partially or fully replenishes or enhances said breast milk stem cell-deficient human breast milk with respect to said BSCs. In some embodiments, the breast milk stem cell-deficient human breast milk is said mother's own pasteurised and/or previously-frozen milk. In alternative embodiments, the breast milk stem cell-deficient human breast milk is pasteurised human donor breast milk.

In some embodiments, the infant is an at-risk infant selected from the group of preterm infants, low birth weight infants and sick infants. Often the infant is a preterm infant.

In another aspect, the present invention relates to a nutritional composition when prepared according to the process above.

The invention includes the following additional aspects or embodiments or variations set forth in the following alphanumerically labeled paragraphs:

A1. A composition comprising a first component in admixture with a second component, said first component containing nutrition for a human infant; and said second component comprising breast milk stem cells (BSCs).

P1. A process for making a composition suitable for administration to a human infant, the process comprising: mixing a first component with a second component, said first component containing nutrition for a human infant; and said second component comprising breast milk stem cells (BSCs).

A2. The composition according to paragraph A1, or the process according to paragraph P1, wherein the BSCs have been isolated from milk from the infant's biological mother.

A3. The composition or process according to paragraph A1, P1, or A2, wherein the BSCs obtained from the milk of the mother have been proliferated in culture prior to mixing with the first component. In some variations, the BSCs have been proliferated in BSC spheroid culture.

A4. The composition or process according to any one of paragraphs A1 to A3 or P1, wherein the first component is a stem-cell deficient nutritional composition.

A5. The composition or process according to any one of paragraphs A1 to A4 or P1, wherein the first component comprises human breast milk.

A6. The composition or process according to paragraph A5, wherein the human breast milk has been processed by pasteurization or filtration.

A7. The composition or process according to paragraph A5 or A6, wherein the first component comprises human breast milk from a human female who is not the biological mother of the infant and who is not the source of the BSCs. In some variations, the milk has been concentrated, frozen, sterilized, and/or pasteurized.

A8. The composition or process according to any one of paragraphs A5 to A7, wherein the first component comprises human breast milk from the biological mother of the infant.

A9. The composition or process according to any one of paragraphs A1 to A8 or P1, wherein the first component comprises a synthetic infant formula.

A10. The composition according to any one of paragraphs A1 to A9, wherein the concentration or density of BSCs in the composition is similar to the concentration or density in freshly-expressed human breast milk. In some embodiments, the concentration or density is within 5%, or within 10%, or within 15%, or within 20% of the mother's freshly expressed milk, or an average determined with respect to fresh expressed human breast milk.

A11. The composition according to any one of paragraphs A1 to A9, wherein the concentration or density of BSCs in the composition exceeds the concentration or density in freshly-expressed human breast milk.

A12. Use of any one of the compositions described herein to provide nutrition to a human infant; use of any one of the compositions described herein to provide prophylaxis to a human infant at risk for any disease or condition, including but not limited to diseases or conditions specifically identified herein; use of any one of the compositions described herein to provide therapy to a human infant having any of these diseases or conditions; or combinations of any of the foregoing.

B1. A method comprising feeding to a human infant any composition described herein, in a nutritionally effective amount.

B2. The method according to paragraph B1, wherein the human infant is an at-risk infant such as a preterm infant, a low birth weight infant, or a sick infant.

B3. The method according to paragraph B1 or B2, wherein the infant is selected because the mother's own milk supply is insufficient to satisfy the nutritional needs of the infant.

B4. The method according to paragraph B1 or B2, wherein the feeding is performed through a tube, such as an oral-gastric tube, a naso-gastric tube, a naso-jejunal tube, a gastric tube, or a gastric-jejunal tube; or is performed orally through a synthetic nipple.

P2. The process according to paragraph P1, further comprising a step of proliferating in culture the BSCs obtained from the milk of the mother, prior to mixing with the first component. In some variations, the BSCs are proliferated in BSC spheroid culture.

P3. The process according to paragraph P1 or P2, further comprising a step, prior to the mixing step, of isolating the BSCs from mother's milk.

P4. The process according to any one of paragraphs P1 to P3, wherein the second component is mixed with the first component in an amount effective to make a composition having a concentration or density of BSCs similar to the concentration or density in freshly expressed human breast milk. In some embodiments, the concentration or density is within 5%, or within 10%, or within 15%, or within 20% of the mother's freshly expressed milk, or an average determined with respect to fresh expressed human breast milk.

P5. The process according to any one of paragraphs P1 to P3, wherein the second component is mixed with the first component in an amount effective to make a composition having a concentration or density of BSCs that exceeds the concentration or density in freshly expressed human breast milk.

P6. The process according to any one of the previous process paragraphs, further comprising feeding the composition obtained from the mixing to the infant.

### Bacterial Compositions and Processes

The present disclosure relates generally to a composition for feeding an infant. More particularly, the disclosure relates to a composition including a first component of processed human breastmilk with a substantially reduced live bacterial cell count, as compared to unprocessed or fresh breastmilk, and a second component comprising at least one live bacterium derived from the infant's mother's own breast milk. The second component is added to the first component, and the at least one bacterium can proliferate to partially or fully replenish the processed human breast milk with respect to the at least one live bacterium.

As indicated above, postnatal exposure to the plethora of bacteria present in human breast milk have profound effects on the bacterial colonisation of the infant's gut as well as on the maturation of the infant's still naive immune system. In fact, bacterial exposure of the breast milk-fed infant has been suggested to exert beneficial effects reducing the infant's risk factors and providing protection against a number of diseases.

As such, bacteria from human breast milk and/or the lactating human mammary gland, such as the nipple or areolar region, play a vital role in the infant's physiology and in the development of the immune system. The fact that bacteria belonging to the same genera have been isolated from aseptically-collected, fresh breast milk samples from healthy women across the globe indicates that their presence in breast milk is not due to contamination—rather, it has been established that these bacteria are part of the natural microbiota of human breast milk. As such, and as indicated above, breast milk-fed preterm infants have a decreased susceptibility to diseases. Conversely, a skewed microbial milk composition can have significant consequences on infant health.

In another aspect the present disclosure relates to a composition for feeding an infant, said composition comprising a first component, said first component providing the majority of the nutritional value to the composition, and a second component, said second component comprising at least one bacterium, wherein said bacterium is a live bacterium from said infant's mother's own milk. Alternatively, said bacterium is a live bacterium from other areas of said infant's mother, including but not limited to, the nipple or areolar region, vaginal, rectal, oral and skin.

The composition can provide a personalised feed composition for the infant—for example, when the infant's mother's own milk supply is not sufficient to provide an adequate volume of own breast milk (and therefore also not sufficient to provide adequate nutrition) to the infant, i.e. many mothers do not have sufficient quantities of milk for their infant. The first and second components can be conducive to the proliferation of said live bacterium. In one approach, the bacterium can be expanded in culture and then be added to the second component.

In some exemplary embodiments, the second component is the mother's own unprocessed milk. In alternative embodiments, the second component is the mother's own milk which has been concentrated, typically by ultrafiltration.

The first component can be human breast milk. Generally, the human breast milk of the first component has been processed. In some exemplary embodiments, the processed human breast milk of the first component is from the mother. Typically, in such instances, the processed human breast milk is the mother's own pasteurised and/or previously-frozen milk. In alternative embodiments, the processed human breast milk of the first component is not from the infant's mother. Typically, in these instances, the first component is pasteurised human donor breast milk. Mostly, the human breast milk has been processed for handling and/or storage. In some exemplary embodiments, the human breast milk has been sterilised. In others, and as indicated above, it has been pasteurised or frozen.

In some embodiments of the present disclosure, the first component is infant formula.

As indicated above, the second component of the composition of the disclosure generally comprises a live bacterium derived from human breast milk. In some exemplary embodiments, the composition according to the disclosure comprises the bacterium in an amount similar to the amount of the bacterium found in a corresponding volume of the mother's own unprocessed breast milk.

Typically though, the second component of the composition according to the disclosure comprises two or more different live bacteria. The relative proportions of the two or more bacteria in the composition substantially mirror the relative proportions of the two or more bacteria in the mother's own unprocessed milk. When the second component is added to the processed human breast milk, it partially or fully replenishes the processed human breast milk with respect to the bacterium or the two or more bacteria lost during processing

The composition of the disclosure is for feeding an at-risk infant selected from the group of preterm infants, low birth weight infants and sick infants. Typically, it is for feeding a preterm infant.

In another aspect, the present disclosure relates to a personalised feed composition for a preterm infant, wherein said composition comprises processed human breast milk with a substantially reduced live bacterial cell count as compared to unprocessed breast milk but to which at least one live bacterium from the infant's mother's own breast milk is added, such that said processed human breast milk is partially or fully replenished with respect to the at least one live bacterium.

The processed human breast milk can be the mother's own pasteurised and/or previously-frozen milk. Alternatively, the processed human breast milk is pasteurised human donor breast milk.

In another aspect, the present disclosure relates to a personalised feed composition for feeding an infant, said composition comprising:

(a) either processed human breast milk or infant formula as a first component, wherein said first component provides the majority of the nutritional value to the composition; and

(b) the infant's mother's own unprocessed breast milk as a second component, wherein said second component provides live bacteria of the mother's own breast milk microbiota to the composition.

In another aspect, the present disclosure relates to a composition for feeding an at-risk infant selected from the group of preterm infants, low birth weight infants and sick infants, said composition comprising:

(a) a first component providing the majority of the nutritional value to the composition; and

(b) a second component providing at least one live bacterium, preferably two or more live bacteria, from said infant's mother's breast milk microbiota to the composition,

wherein at least the first component is conducive to the proliferation of said at least one live bacterium, preferably two or more live bacteria, such that, at the time of being fed to said infant, said composition comprises said at least one live bacterium, preferably two or more live bacteria, from said mother's breast milk microbiota in an amount similar to the amount of said at least one live bacterium, preferably two or more live bacteria, found in a corresponding volume of said mother's own unprocessed breast milk.

In another aspect, the present disclosure relates to a process of preparing a personalised infant feed composition, said process comprising the steps of

a) determining the bacterial profile of an infant's mother's own unprocessed breast milk;

b) providing a first component, said first component providing the majority of the nutritional value to the composition;

c) providing a second component comprising at least one live bacterium determined as being present in said mother's own milk in step a); and

d) adding said second component to said first component.

The process further comprises the step of c₁) maintaining the second component under conditions conducive to the proliferation of the at least one bacterium such that the amount of the bacterium is increased prior to adding the second component to the first component in step d).

Alternatively, the process further comprises the step of e) maintaining the composition under conditions conducive to the proliferation of the at least one bacterium such that the amount of the bacterium is increased prior to feeding of the composition to the infant.

In some embodiments of the process, the first component is processed human breast milk and the second component comprises two or more different live bacteria at relative proportions substantially mirroring the relative proportions of the two or more bacteria in the mother's own unprocessed breast milk such that adding the second component to the first component partially or fully replenishes the processed human breast milk with respect to the two or more bacteria.

In other exemplary embodiments, the composition comprises the bacterium in an amount similar to the amount of the bacterium found in a corresponding volume of the mother's own unprocessed breast milk.

The processed human breast milk can be the mother's own pasteurised and/or previously-frozen milk. Alternatively, the processed human breast milk can be pasteurised human donor breast milk.

The personalised infant feed composition prepared by the process above can be a personalised infant feed composition for feeding an at-risk infant selected from the group of preterm infants, low birth weight infants and sick infants. Typically, the at-risk infant is a preterm infant.

In another aspect, the present disclosure relates to a composition when prepared according to the process above.

In another aspect, the present disclosure relates to a process of replenishing the live bacterial cell count of at least one live bacterium in processed human breast milk, wherein said processed human breast milk has a substantially reduced live bacterial cell count as compared to unprocessed breast milk, to produce a personalised feed composition for a preterm infant, said process comprising the steps of:

a) obtaining said at least one live bacterium from an infant's mother's own breast milk or from the mother's lactating mammary gland;

b) adding an amount of said at least one live bacterium to said processed breast milk to obtain a mixture; and

c) maintaining said mixture under conditions conducive to the proliferation of said at least one live bacterium,

such that after step c), said composition comprises an amount of said at least one live bacterium that is greater than the amount of said at least one live bacterium added at step b).

The amount of said at least one live bacterium in the composition to be fed is similar to the amount of said at least one live bacterium found in a corresponding volume of the mother's own breast milk prior to processing. Typically, the processed human breast milk is replenished with two or more different live bacteria.

In some exemplary embodiments, the processed human breast milk is the mother's own pasteurised and/or previously-frozen breast milk. Alternatively, the processed human breast milk is pasteurised human donor breast milk.

The invention includes the following additional aspects or embodiments or variations set forth in the following alphanumerically labeled paragraphs:

C1. A composition comprising a first component in admixture with a second component, said first component containing nutrition for a human infant and being substantially free of living bacteria; and said second component comprising at least one live bacterium, wherein said live bacterium is from said infant's biological mother.

C2. The composition according to paragraph C1, wherein the bacterium from the infant's biological mother is obtained from the mother's breast milk, nipple, areola, skin, vagina, rectum, or mouth.

C3. The composition according to paragraphs C1 or C2, wherein the bacterium is from a bacterial culture obtained from the mother and expanded in culture. In some variations, bacteria are obtained from the mother; one or more desirable strains are isolated and/or preferentially expanded in culture; and the one or more desirable strains are used as the at least one live bacterium.

C4. The composition according to any one of paragraphs C1 to C3, wherein the first component comprises human breast milk processed by pasteurization or filtration to be substantially free of living bacteria.

C5. The composition according to any one of paragraphs C1 to C4, wherein the first component comprises human breast milk from a human female who is not the biological mother of the infant and who is not the source of the bacterium.

C6. The composition according to any one of paragraphs C1 to C4, wherein the first component comprises a synthetic infant formula.

C7. Use of any one of the compositions described herein to provide nutrition to a human infant; use of any one of the compositions described herein to provide prophylaxis to a human infant at risk for any disease or condition, including but not limited to diseases or conditions specifically identified herein; use of any one of the compositions described herein to provide therapy to a human infant having any one of these diseases or conditions; or combinations of any of the foregoing.

D1. A method comprising administering to a human infant any composition described herein, in a nutritionally effective amount.

D2. The method according to paragraph D1, wherein the human infant is an at-risk infant such as a preterm infant, a low birth weight infant, or a sick infant.

D3. The method according to paragraph D1 or D2, wherein the infant is selected because the mother's own milk supply is insufficient to satisfy the nutritional needs of the infant.

D4. The method according to paragraph D1 or D2, wherein the administering is performed through a tube, such as an oral-gastric tube, a naso-gastric tube, a naso-jejunal tube, a gastric tube, or a gastric-jejunal tube; or is performed orally through a synthetic nipple.

### Combination BSC and Bacterial Products and Processes

Also contemplated as an aspect of the invention are compositions that provide nutritional value for infants and that are enhanced with both breast milk stem cells and with bacterial cells (each summarized above and described below individually in detail.)

Further contemplated as an aspect of the invention are methods of making compositions that provide nutritional value for infants and that are enhanced with both breast milk stem cells and with bacterial cells (each summarized above and described below individually in detail.) Such methods comprise, for example, mixing the components together to form a single composition in admixture at some time prior to administration or feeding to an infant. The components can be mixed simultaneously or in any order. In some variations, first formed is a composition comprising a first component in admixture with a second component, said first component containing nutrition for a human infant and being substantially free of living bacteria; and said second component comprising at least one live bacterium, wherein said live bacterium is from said infant's biological mother. To this composition, a third component is added that includes BSCs.

Additionally contemplated as an aspect of the invention are methods of using compositions that provide nutritional value for infants and that are enhanced with both breast milk stem cells and with bacterial cells (each summarized above and described below individually in detail.) Such methods of using comprise, for example administering and/or feeding the composition to an infant as described elsewhere herein.

In another variation of this aspect of the invention that provides both BSCs and bacterium, some variations of this aspect of the (at least) three-component invention, the source of the bacterium is a probiotic culture, in addition to, or instead of, bacterium derived directly from the mother. Non-limiting examples of bacteria with particular importance for the present disclosure are: Enterobacteriaceae, Neisseriaceae, Comamonadaceae, Xanthomonadaceae, Moraxellaceae, Enterococcaceae, Carnobacteriaceae, Staphylococcaceae, Streptococcaceae, Bacillaceae, Leuconostocaceae, Selenomonadales, Leptotrichiaceae, Corynebacteriaceae, or more specifically, Lactobacillus acidophilus, Lactobacillus fermentum, Staphylococcus epidermidis, Streptococcus mitis, Streptococcus salivarius, Lactobacillus plantarum, Streptococcus spp., Enterococcus faecium, Lactobacillus gasseri, Enterococcus faecalis, Lactobacillus crispatus, Lactobacillus rhamnosus, Lactococcus lactis, Leuconostoc mesenteroides, Rothia mucilaginosa, Staphylococcus aureus, Staphylococcus capitis, Staphylococcus hominis, Streptococcus oris, Streptococcus parasanguis, Lactobacillus salivarius, Corynebacterium spp., Enterococcus spp., Lactobacillus spp., Peptostreptococcus spp., Staphylococcus spp., Lactobacillus reuteri, Bifidobacterium adolescentis, Bifidobacterium bifidum, Bifidobacterium breve, Bifidobacterium longum, Bifidobacterium longum ssp infantis, Kocuria rhizophila, Lactobacillus casei, Lactobacillus gastricus, Lactobacillus vaginalis, Pediococcus pentosaceus, Streptococcus lactarius, Enterococcus durans, Enterococcus hirae, Enterococcus mundtii, Lactobacillus animalis, Lactobacillus brevis, Lactobacillus helveticus, Streptococcus australis, Streptococcus gallolyticus, Streptococcus vestibularis, Leuconostoc citreum, Leuconostoc fallax, Propionibacterium acnes, Weissella cibaria, Weissella confusa, Clostridium spp., Bifidobacterium animalis, Bifidobacterium animalis ssp lactis Bifidobacterium catenolatum, Bifidobacterium spp., Enterococcus spp., Bradyrhizobiaceae, Propionibacterium spp., Pseudomonas spp., Ralstonia spp., Serratia spp., Sphingomonas spp., Stenotrophomonas spp., Citrobacter spp., Corynebacterium spp. Veillonella spp. Lysinibacillus spp., Carnobacterium spp., Granulicatella spp., Prevotella spp. Gemella spp. and Acinetobacter spp., or combinations thereof.

Exemplary embodiments of the combination are set forth in the following numbered paragraphs:

1. A composition comprising first, second, and third components in admixture: said first component containing nutrition for a human infant; said second component comprising breast milk stem cells (BSCs); and said third component comprising at least one live bacterium.

2. A process for making a composition suitable for administration or feeding to a human infant, the process comprising: mixing a first, second, and third components to form the composition, said first component containing nutrition for a human infant; said second component comprising breast milk stem cells (BSCs); and said third component comprising at least one live bacterium.

3. The composition or process according to paragraph 1 or 2, wherein the live bacterium is from said infant's biological mother.

4. The composition or process according to paragraph 3, wherein the bacterium from the infant's biological mother is obtained from the mother's breast milk, nipple, areola, skin, vagina, rectum, or mouth.

5. The composition or process according to any one of paragraphs 1 to 4, wherein the bacterium is from a bacterial culture obtained from the mother and expanded in culture.

6. The composition or process according to any one of paragraphs 1 to 5, wherein the first component comprises human breast milk.

7. The composition or process according to paragraph 6, wherein the human breast milk has been processed by pasteurization or filtration.

8. The composition or process according to paragraph 7, wherein the human breast milk of the first component is substantially free of living bacteria and/or substantially free of living BSCs.

9. The composition or process according to any one of paragraphs 1 to 8, wherein the first component comprises human breast milk from a human female who is not the biological mother of the infant and who is not the source of the bacterium.

10. The composition or process according to any one of paragraphs 1 to 9, wherein the first component comprises human breast milk from the biological mother of the infant.

11. The composition or process according to any one of paragraphs 6 to 10, wherein the breast milk has been concentrated or frozen.

12. The composition or process according to any one of paragraphs 1 to 11, wherein the first component comprises a synthetic infant formula.

13. The composition or process according to any one of paragraphs 1 to 12, wherein the BSCs have been isolated from milk from the infant's biological mother.

14. The composition or process according to any one of paragraphs 1 to 13, wherein the BSCs obtained from the milk of the mother have been proliferated in culture prior to mixing.

15. The composition of process according to paragraph 14, wherein the BSCs have been proliferated in BSC spheroid culture.

16. The composition or process according to any one of paragraphs 1 to 15, wherein the first component is a stem-cell deficient nutritional composition.

17. The composition or process according to any one of paragraphs 1 to 16, wherein the first component comprises a synthetic infant formula.

18. The composition according to any one of paragraphs 1 and 3-17, wherein the concentration or density of BSCs in the composition is similar to the concentration or density in freshly expressed human breast milk.

19. The composition according to any one of paragraphs 1 and 3-17, wherein the concentration or density of BSCs in the composition exceeds the concentration or density in freshly expressed human breast milk.

20. The process according to any one of paragraphs 2 to 17, wherein the first component is mixed with the second component to form a BSC nutritional mixture, and the BSC nutritional mixture is mixed with the third component.

21. The process according to any one of paragraphs 2 to 17, wherein the first component is mixed with the third component to form a bacteria-containing nutritional mixture, and the bacteria-containing nutritional mixture is mixed with the third component.

22. The process according to any one of paragraphs 2-17 and 20-21, further comprising a step of proliferating in culture the BSCs obtained from the milk of the mother, prior to mixing with the first component. In some variations, the BSCs are proliferated in BSC spheroid culture.

23. The process according to any one of paragraphs 2-17 and 20-22, further comprising a step, prior to the mixing step, of isolating the BSCs from mother's milk.

24. The process according to any one of paragraphs 2-17 and 20-23, wherein the second component is mixed with the first component in amount effective to make a composition having concentration or density of BSCs similar to the concentration or density in freshly expressed human breast milk.

25. The process according to any one of paragraphs 2-17 and 20-23, wherein the second component is mixed with the first component in amount effective to make a composition having concentration or density of BSCs that exceeds the concentration or density in freshly expressed human breast milk.

26. The process according to any one of paragraphs 2-17 and 20-25, further comprising feeding the composition obtained from the mixing to the infant.

27. Use of the composition according to any one of paragraphs 1 and 3-19 to provide nutrition to a human infant.

28. Use of the composition according to any one of paragraphs 1 and 3-19 to provide prophylaxis to a human infant at risk for any disease or condition, including but not limited to diseases or conditions specifically identified herein.

29. Use of the composition according to any one of paragraphs 1 and 3-19 to provide therapy to a human infant having any of the diseases or conditions described herein.

30. A process comprising feeding to a human infant any composition according to any one of paragraphs 1 and 3-19, in a nutritionally effective amount.

31. The process according to paragraph 30, wherein the human infant is an at-risk infant such as a preterm infants, a low birth weight infant, and a sick infant.

32. The process according to paragraph 30 or 31, wherein the infant is selected because the mother's own milk supply is insufficient to satisfy the nutritional needs of the infant.

33. The process according to any one of paragraphs 30 to 32 , wherein the feeding is performed through a tube, such as an oral-gastric tube, a naso-gastric tube, a naso-jejunal tube, a gastric tube, or a gastric-jejunal tube; or is performed orally through a synthetic nipple.

Non-cellular aspects and variations

Additional exemplary embodiments and variations relating to supplementation with components that may be non-cellular in nature. Such components include, but are not limited to, bioactive proteins such as enzymes; vitamin and mineral transporting and binding proteins; and proteins with immunological and anti-infective properties. The nutrient compositions that can be supplemented according to this aspect of the invention include human and non-human milk-based compositions and formula compositions. These aspects of the invention can be practiced independently of, or in combination with, cellular fortification aspects described herein.

Exemplary embodiments are summarized by the following paragraphs:

E1. A method of preparing a milk-based food for a human infant comprising:

(a) assaying a sample of a feed, the feed comprising human breast milk, to measure the quantity or activity of at least one non-cellular organic component(s);

(b) identifying a deficiency in the quantity or activity of at least one of the at least one non-cellular organic component(s) in the feed sample; and

(c) supplementing the feed with one or more of: (1) living cells that produce a non-cellular organic component identified as being deficient in (b); (2) a quantity of said non-cellular organic component in cell-free, biologically active form; and (3) unpasteurized, unfrozen human breast milk that contains (1) or (2), to reduce the deficiency identified in (b).

E2. The method of paragraph E1, wherein the human breast milk of step (a) has been frozen and/or pasteurized prior to the assaying.

E3. A method of preparing a milk-based food for a human infant comprising:

(a) providing a feed that comprises pasteurized human breast milk;

(b) supplementing the feed with one or more of: (1) living cells that produce a non-cellular organic component of human breast milk that is destroyed or inactivated by pasteurization; (2) a quantity of said non-cellular organic component in cell-free, biologically active form; and (3) unpasteurized, unfrozen human breast milk that contains (1) or (2), to replace a deficiency in said component resulting from the pasteurization.

E4. The method according to any one of paragraphs E1-E3, wherein the at least one non-cellular organic component contributes to the digestibility of the feed or the bioavailability of a nutrient component of the feed.

E5. The method according to any one of paragraphs E1-E4, wherein the human breast milk in the feed of (a) comprises donor breast milk from a human female who is not the biological mother of the human infant.

E6. The method of any one of paragraphs E1-E5, wherein the at least one non-cellular organic component comprises an enzyme capable of digestion of a component of human breast milk, to improve absorption or bioavailability in a human infant.

E7. The method of paragraph E6, wherein the enzyme is a lipase.

E8. The method of any one of paragraphs E1-E7, wherein the at least one non-cellular organic component comprises a vitamin transporting protein.

E9. The method of paragraph E8, wherein the at least one vitamin transporting protein comprises haptocorrin.

E10. The method of any one of paragraphs E1-E9, wherein the at least one non-cellular organic component comprises an immunomodulatory protein.

E11. The method of paragraph E10, wherein the immunomodulatory protein comprises a lactoferrin protein.

E12. The method of any one of paragraphs E1-E11, wherein the at least one non-cellular organic component used for the supplementing is purified and isolated from human breast milk.

E13. The method of any one of paragraphs E1-E12, wherein the at least one non-cellular organic component used for the supplementing is provided by unpasteurized, never-frozen human breast milk from the biological mother of the human infant.

E14. The method of paragraph E13, wherein the at least one non-cellular organic component used for the supplementing is provided by concentrated unpasteurized, never-frozen human breast milk.

E15. The method according to any one of paragraphs E1-E14, further comprising adding breast milk stem cells (BSCs) to the feed.

E16. The method according to any one of paragraphs E1-E15, further comprising adding at least one live bacterium to the feed.

E17. The method of any one of paragraphs E1- E16, further comprising feeding the supplemented feed to a human infant.

E18. The method of paragraph E17, wherein the human infant is a pre-term infant.

E19. A milk-based food prepared according to the method of any one of paragraphs E1-E16.

E20. An infant feeding device containing a milk-based food according to paragraph E19.

E21. A device comprising:

(1) a milk chamber for receiving human breast milk;

(2) at least one reagent chamber; and

(3) at least one reaction chamber for mixing a sample of the human breast milk with at least one reagent from the at least one reagent chamber.

E22. The device according to paragraph E21, further comprising:

(4) a detector to provide a quantitative indication of at least one reaction product(s) from the sample of the human breast milk and the reagent.

E23. The device according to paragraph E20 or E21, further comprising at least one supplement chamber to hold at least one nutritional supplement suitable for addition to human breast milk.

E24. The device according to paragraph E23, wherein the at least one reagent chamber contains reagent(s) for measuring the quantity and/or activity of at least one non-cellular organic component of human milk; and the at least one supplement chamber contain(s) at least one nutritional supplement that comprises said at least one non-cellular organic component measurable with the reagent(s).

E25. The device according to paragraph E24, further comprising an infant feeding device operably connected to the at least one reagent chamber to receive a measured amount of nutritional supplement from the at least one supplement chamber.

E26. The device according to paragraph E25, wherein the infant feeding device comprises a bottle, a syringe, or an enteral pump.

### Additional Aspects and Variations

For both processes and compositions of the invention, variations are contemplated in which additional components, e.g., fortifiers, are added to the composition. Such additional components may include, for example, a mineral supplement such as a calcium, magnesium, iron, sodium, potassium, or phosphorous supplement; a vitamin supplement, such as a vitamin A, B, C, D, K, niacin, or folic acid supplement; a protein or amino acid supplement (such as a protein supplement containing protein or protein fragments from non-human mammals (e.g., cow or lamb) or non-human mammalian milk); and a lipid of fatty acid supplement (such as a fat or oil or fatty acid supplement from non-human animals, including fish or mammals, or from a plant, including algal or land-plant oils, and especially a supplement containing essential fatty acids or essential fatty acid precursors, including omega-3 and omega-6 fatty acids. Compositions that further comprise one or more of these fortifiers, and processes that include adding them; and processes of using the compositions formed with them, all are contemplated as aspects of the invention.

Aspects of the invention that have been described herein as methods also can be described as “uses” and all such uses are contemplated as aspects of the invention. Likewise, compositions described herein as having a “use” can alternatively be described as processes or methods of using, which are contemplated as aspects of the invention.

Reference throughout this specification to “one embodiment”, “some embodiments” or “an embodiment” means that a particular feature, structure or characteristic described in connection with the embodiment is included in at least one embodiment of the present disclosure. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

The headings herein are for the convenience of the reader and not intended to be limiting. Additional aspects, embodiments, and variations of the invention will be apparent from the Detailed Description and/or claims.

The invention includes, as an additional aspect, all embodiments of the invention narrower in scope in any way than the variations defined by specific paragraphs above. For example, where certain aspects of the invention that are described as a genus or set, it should be understood that every member of a genus or set is, individually, an aspect of the invention.

Although the applicant(s) invented the full scope of the invention described herein, the applicants do not intend to claim subject matter described in the prior art work of others. Therefore, in the event that statutory prior art within the scope of a claim is brought to the attention of the applicants by a Patent Office or other entity or individual, the applicant(s) reserve the right to exercise amendment rights under applicable patent laws to redefine the subject matter of such a claim to specifically exclude such statutory prior art or obvious variations of statutory prior art from the scope of such a claim. Variations of the invention defined by such amended claims also are intended as aspects of the invention.

In the context of this specification the following terms are defined as follows:

### “Comprising”

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

### “Stem Cell-Deficient”

In the context of this specification the term “stem cell-deficient” means that the components of the compositions referred to do not naturally comprise stem cells such as, for example, infant formula. Alternatively, if the components referred to are breast milk-based and would naturally comprise stem cells, the term indicates that these components have a substantially-reduced stem cell count due to processing, whereas in this context the terms “processing” or “processed” include handling and storage of the breast milk-based component without any further explicit manipulation.

The term “stem cell count” means the number of cells identified as stem cells in a predetermined volume of breast milk at the time of counting/measurement.

A substantially-reduced breast milk stem cell count can be considered a breast milk stem cell count of less than 90%, less than 85%, less than 80%, less than 75%, less than 70%, less than 65%, less than 60%, less than 55%, less than 50%, less than 45%, less than 40%, less than 35%, less than 30%, less than 25%, less than 20%, less than 15%, less than 10%, or less than 5% of viable stem cells when compared to the total stem cell count of the sample, i.e. including apoptotic and/or dead stem cells, and wherein the sample is a fresh breast milk sample.

### “Expanded in Culture” (for BSCs)

In the context of the present specification in the context of BSCs, the term “expanded in culture” refers to the process of multiplying BSCs in predetermined culture conditions. For example, culturing BSCs in 3D spheroid culture will provide conditions conducive to proliferation and enrichment of BSCs thereby “expanding the BSCs in culture”. It will be understood that after having been “expanded in culture”, at the end of a period of culture, the total number of BSCs available is greater than at the initiation of the culture period. Exemplary methods of expanding BSCs in culture are described below and also in Australian patent 2012202353 and its divisional application 2014202292 (corresponding to U.S. patent application Ser. Nos. 13/866,221 and 14/264,047, respectively), the disclosures of which are hereby expressly incorporated into the present specification in their entirety.

In the context of the present specification the terms “multiply”, “multiplying”, “multiplication” etc. are interchangeably used with the terms “proliferate”, “proliferating”, “proliferation”, etc., and unless the context clearly dictates otherwise, are synonymous when used with respect to BSCs.

### “Bacterium”

In the context of the present specification, the terms “bacterium” or “bacteria” refer to the well-known domain of prokaryotic microorganisms. As such, in some instances, the term “bacterium” may be used as a general descriptor and may encompass bacteria from different bacterial phyla, classes, orders, families and genera species, strains or phylotypes. However, typically, and unless the context dictates otherwise, when a bacterium is being distinguished from another bacterium in the context of this specification, the distinction is due to the taxonomic difference between the two organisms and the term “a bacterium” is not meant to mean “a single bacterial cell”.

Non-limiting examples of bacteria with particular importance for the present disclosure are: Enterobacteriaceae, Neisseriaceae, Comamonadaceae, Xanthomonadaceae, Moraxellaceae, Enterococcaceae, Carnobacteriaceae, Staphylococcaceae, Streptococcaceae, Bacillaceae, Leuconostocaceae, Selenomonadales, Leptotrichiaceae, Corynebacteriaceae, or more specifically, Lactobacillus acidophilus, Lactobacillus fermentum, Staphylococcus epidermidis, Streptococcus mills, Streptococcus salivarius, Lactobacillus plantarum, Streptococcus spp., Enterococcus faecium, Lactobacillus gasseri, Enterococcus faecalis, Lactobacillus crispatus, Lactobacillus rhamnosus, Lactococcus lactis, Leuconostoc mesenteroides, Rothia mucilaginosa, Staphylococcus aureus, Staphylococcus capitis, Staphylococcus hominis, Streptococcus oris, Streptococcus parasanguis, Lactobacillus salivarius, Corynebacterium spp., Enterococcus spp., Lactobacillus spp., Peptostreptococcus spp., Staphylococcus spp., Lactobacillus reuteri, Bifidobacterium adolescentis, Bifidobacterium bifidum, Bifidobacterium breve, Bifidobacterium longum, Bifidobacterium longum ssp infantis, Kocuria rhizophila, Lactobacillus casei, Lactobacillus gastricus, Lactobacillus vaginalis, Pediococcus pentosaceus, Streptococcus lactarius, Enterococcus durans, Enterococcus hirae, Enterococcus mundtii, Lactobacillus animalis, Lactobacillus brevis, Lactobacillus helveticus, Streptococcus australis, Streptococcus gallolyticus, Streptococcus vestibularis, Leuconostoc citreum, Leuconostoc fallax, Propionibacterium acnes, Weissella cibaria, Weissella confusa, Clostridium spp., Bifidobacterium animalis, Bifidobacterium animalis ssp lactis Bifidobacterium catenolatum, Bifidobacterium spp., Enterococcus spp., Bradyrhizobiaceae, Propionibacterium spp., Pseudomonas spp., Ralstonia spp., Serratia spp., Sphingomonas spp., Stenotrophomonas spp., Citrobacter spp., Corynebacterium spp. Veillonella spp. Lysinibacillus spp., Carnobacterium spp., Granulicatella spp., Prevotella spp. Gemella spp. and Acinetobacter spp., or combinations thereof.

The term “beneficial bacterium” or “beneficial bacteria” refers to non-pathogenic bacteria and/or bacteria which convey a desirable effect to an infant when ingested.

### “Expanded in Culture”(for Bacterium)

In the context of the present specification and its discussion of bacterium, the term “expanded in culture” refers to the process of multiplying a bacterium in predetermined culture conditions. For example, liquid bacterial culture under conditions conducive to proliferation allows for the multiplication of bacteria to occur in the liquid culture medium, such that the number of bacterial cells can be increased, i.e. such that at the end of a period of culture, the total number of bacterial cells in the culture medium is greater than at the initiation of the culture period.

In the context of the present specification the term “culture medium” encompasses all media conducive to the multiplication of bacterial cells. The terms “multiply”, “multiplying”, “multiplication” etc. are interchangeably used with the terms “proliferate”, “proliferating”, “proliferation”, etc. throughout the specification and, unless the context clearly dictates otherwise, are synonymous when used with respect bacteria.

### “Nutritional Composition”

In the context of this specification the phrases “nutritional composition for feeding an infant” or “a nutritional infant feed composition” are used interchangeably and refer to compositions the main aim of which is to provide nourishment to an infant who is not in a position to enjoy the full benefits of being breastfed directly. Nutritional compositions in this context include: breast milk-based compositions such as, for example, freshly-expressed, thawed or otherwise processed mother's own breast milk; or donor milk, particularly pasteurised or sterilised donor breast milk; and infant formula compositions.

### “Mother's Milk”

In the context of this specification the term “mother's milk” refers to all forms of human mother's milk, including any human milk components, and/or mammary gland secretions, such as colostrums. When referring to “mother's own milk”, mother's milk of a particular mother for feeding to her own infant is meant.

### “Personalised”

In the context of the present specification, the term “personalised”, for example when referring to “personalised infant feed compositions”, “personalised compositions”, etc. means that the compositions referred to have been designed and prepared to substantially satisfy the individual requirements of the recipient, i.e. in the context of the present specification, the requirements of each individual infant.

It will be appreciated that the preparation of infant feed compositions, including BSCs based on the individual needs of the infant will “personalise” the resulting composition for the individual infant.

It will be appreciated that the preparation of infant feed compositions, including a particular selection of bacteria at particular concentrations and relative proportions based on the bacterial profile determined for the infant's mother's own breast milk, will “personalise” the resulting composition for the individual infant.

Furthermore, in the context of the present specification, a “personalised” composition may also be “maternally-matched”, which means that a composition has been prepared using a first component of mother's own stem cell-deficient breast milk and a second component comprising BSCs from the same mother's breast milk for feeding her own infant. Such personalised and maternally-matched compositions provide the infant with non-autologous, yet uniquely-matched BSCs having a favourable immunogenicity profile. It will be appreciated that such a degree of personalisation of an infant feed composition can otherwise only be achieved by the mother's own, fresh breast milk.

### “Replenish” (BSCs)

In the context of the present specification, the term “replenish” is to be construed in its plain English meaning, i.e. “to restore something to a former level or condition”. It will be understood that processing of breast milk, such as pasteurisation, substantially reduces the BSC count of the milk and that, therefore, pasteurised breast milk no longer contains an adequate BSC population. Accordingly, when breast milk is “replenished” according to the methods of the present disclosure, the presence of an adequate BSC population is restored.

As such, it will be understood that the term “replenish” refers to the restoration of a BSC population, i.e. to the restoration of a desirable condition of unprocessed milk. However, the term does not mean that replenished breast milk must have the identical BSC count to the milk prior to processing but that “replenished” breast milk may be “partially” or “fully” replenished, both with respect to quality or the quantity of the BSCs restored.

In some instances, the replenishment of BSCs in a previously stem cell-deficient component can increase the BSC count to above the components natural BSC count thereby enhancing the second component with respect to BSCs.

### “Replenish” (Bacterium)

In the context of the present specification, the term “replenish” is to be construed in its plain English meaning, i.e. “to restore something to a former level or condition”. It will be understood that processing of breast milk, such as pasteurisation, substantially reduces the bacterial cell count of the milk and that, therefore, pasteurised breast milk no longer contains an adequate breast milk microbiota. Accordingly, when breast milk is “replenished” according to the methods of the present disclosure, the presence of an adequate bacterial microbiota is restored.

As such, it will be understood that the term “replenish” refers to the restoration of a milk microbiota, i.e. to the restoration of a desirable condition of unprocessed milk. However, the term does not mean that replenished breast milk must have the identical microbiota to the milk prior to processing but that “replenished” breast milk may be “partially” or “fully” replenished, both with respect to quality of the bacteria (i.e. the bacterial phyla, classes, orders, families and genera species, strains or phylotypes) or the quantity of the bacteria restored.

### “Infant”

In the context of the present application, the term infant refers to all infants, including healthy term infants, preterm infants, low birth weight infants, “at-risk infants”, or neonates, and sick infants.

### “At-Risk Infant”

In the context of the present application, the term “at-risk infant” refers to neonates considered to be in greater danger of health problems than the norm at least during the first month of life. Specifically, the term is meant to include preterm infants, low birth weight infants and sick infants.

### “Preterm Infant”

In the context of the present application, the term “preterm infant” refers to an infant born at a gestational age of less than 37 weeks. The term further encompasses “premature infants”, i.e. infants born before the developing organs are mature enough to allow for normal postnatal survival.

### “Progenitor/Precursor Cell”

Please note that these terms can be used interchangeably and, in so far as the terms refer to cells, they refer to a cell capable of differentiating into a number of cell and/or tissue types of a cell lineage. A cell lineage is to be understood as a genealogic pedigree of cells related through mitotic division.

### “Pluripotent”

In so far as this term refers to cells, the term “pluripotent” refers to a cell capable of differentiating into cell and/or tissue types of all cell lineages, excluding extra embryonic cell and/or tissue types.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Embodiments of the invention will now be described, by way of example only, with reference to the accompanying drawings in which:

FIG. 1A illustrates the morphology of hBSCs and the expression profile of typical ESC markers Oct4, Sox2, Nanog, SSEA4, SSEA3, and Tra-1-60/Tra-1-81 in embryonic stem cell-like colonies derived and specifically expanded in spheroid culture. Cells from breastmilk-derived colonies that did not show ES-like morphology showed reduced ESC marker fluorescence. Positive control cells (ES H7 line) are shown. Additional information on the cell marker detection can be found in Table 1.

FIG. 1B shows breastmilk-derived spheroids as observed by cell morphology and immunofluorescence for ESC markers. Co-expression of several ESC marker genes were observed, and cell nuclei were stained with DAPI.

FIG. 1C shows RT-PCR quantification of mRNA levels for Oct4, Sox2, and Nanog at various time points during spheroid formation. Negative controls (fibroblasts) and positive controls (hESC) are also shown (from U.S. patent application Ser. No. 14/264,047, the disclosure of which is hereby expressly incorporated into the present specification in its entirety).

FIG. 2 illustrates exemplary process steps for achieving an improved digestible infant feed formed from donor milk in accordance with principles described herein.

FIG. 3 illustrates an example of a system including a testing/feeding device for determining desired contents of an improved digestible infant feed.

### DETAILED DESCRIPTION

### BSC Aspects

Described herein are nutritional compositions for feeding an infant and methods of their production.

In particular, and as indicated above, the disclosure relates to a composition for feeding an infant, such as a nutritional composition, comprising a first and a second component, wherein the first component provides the majority of nutrition but is breast milk stem cell (BSC) deficient and wherein the second component comprises BSCs from the infant's mother's own milk. The disclosure has been developed primarily as a composition for feeding a mother's own infant such that appropriate nourishment of the infant is provided together with beneficial BSCs from the infant's mother's own breast milk, even in instances where the circumstances do not allow for the infant to receive full nutrition by way of being fed the mother's own milk directly from the breast. The feed compositions of the present disclosure are therefore “personalised” feed compositions for the mother's infant.

In some instances, the circumstances that do not allow for the at-risk infant to receive the mother's own milk may be that the mother's milk supply is insufficient. In other instances, infant and mother may have to remain separated for prolonged periods of time due to, for example, medical reasons.

As indicated above, the present disclosure relates to infant feed compositions, such as nutritional compositions, that provide both appropriate nourishment as well as beneficial BSCs to the infant. The BSCs can be added to breast milk stem cell-deficient human breast milk or to breast milk stem cell non-deficient human breast milk.

Generally, the first component of the compositions of the disclosure comprises breast milk, stem cell deficient human breast milk, infant formula or a combination of two or more of the foregoing; and the second component comprises BSCs from the infant's mother's own milk. In some variations where the first component comprises breast milk, the breast milk may be unprocessed breast milk from the mother of the infant, and may have viable BSCs. In some variations, the breast milk may be stem cell-deficient, as the stems cells may have become non-viable or may have been removed (e.g., due to storage conditions or due to active processing such as pasteurization or filtration).

In embodiments where the first component of the composition is made up of processed human breast milk, the breast milk generally no longer contains the BSCs it contained prior to its processing. The processed breast milk may be the mother's own breast milk, an individual donor's breast milk or pooled donor breast milk.

Typically, the processed breast milk of the first component is sterilised or pasteurised breast milk, or breast milk that has been refrigerated or frozen thereby rendering the milk BSC-deficient. When sterilised, the processed breast milk does not contain live BSCs. When pasteurised, the BSC count of the processed breast milk breast milk has been substantially reduced subsequent to pasteurisation rendering the milk BSC-deficient. Refrigerated storage of freshly-expressed mother's own breast milk over a period of time will lead to a substantial reduction of the BSC count rendering the milk BSC-deficient. Similarly, freezing freshly-expressed mother's own breast milk will eliminate live BSCs from the milk rendering the milk BSC-deficient. Accordingly, upon thawing, breast milk previously-frozen for storage will be BSC-deficient.

Pasteurised breast milk for use as the first component can be prepared by any pasteurisation method known in the field.

Holder pasteurisation is a low-temperature long-time (LTLT) heat treatment widely used a human milk banks. Breast milk is heat treated for 30 minutes at temperatures greater than 56° C., for example at 62.5° C.

Alternatively, ultraviolet (UV) irradiation may be used to pasteurise breast milk and UV-C pasteurisation at wavelengths between 250 and 270 nm has been shown to be an effective pasteurisation method for human breast milk (Christen et al. The Effect of UV-C Pasteurisation on Bacteriostatic Properties and Immunological Proteins of Donor Human Milk. PLOS 2013, Vol. (8):12, e85867). Further, pascalisation or high pressure processing may be used to pasteurise breast milk.

Processing of breast milk for use in the compositions of the present disclosure includes processing of the milk for handling and storage, such as handling and storage in human breast milk banks. Typically, the breast milk is sterilised or pasteurised. Alternatively, the breast milk breast milk may be refrigerated or frozen for storage.

In embodiments where the first component of the composition is made up of formula, the formula has been carefully (i.e. substantially aseptically) prepared such as to avoid any bacterial contamination, which could increase the risk of bacterial infection for the at-risk infant. In some instances, the formula may be pasteurised subsequent to its initial preparation. In general terms, a formula-based first component will not comprise any stem cells and will be considered stem cell-deficient per se.

In other embodiments, the second component is processed human breast milk to which BSCs have been added. Particularly, the BSCs have been obtained from a mother's own milk and the composition is for feeding the mother's own infant. In some embodiments, the processed human breast milk of the second component is from the mother of the infant for whom the infant feed composition is intended. In alternative embodiments, the processed human breast milk is not from the mother of the infant for whom the infant feed composition is intended, but from another lactating woman such as from a breast milk donor.

In some embodiments the BSCs have been expanded in culture before being added to the second component. This expansion typically comprises proliferation of the BSCs under 3D culture conditions. Of course, the skilled person will appreciate that other BSC culture conditions can be used to expand the BSCs in culture.

Notwithstanding, and as indicated above, in exemplary embodiments of the present disclosure, the BSCs of the second component have been proliferated and enriched in 3D spheroid culture as described in Australian patent 2012202353 and its divisional application 2014202292 (corresponding to U.S. patent application Ser. Nos. 13/866,221 and 14/264,047, respectively), the disclosures of which are hereby expressly incorporated into the present specification in their entirety.

Specifically, and as indicated above, propagation and expansion of hBSCs in 3D culture conditions results in the formation of spheroids with a dramatic up-regulation of transcription factors (TFs) seen in embryonic stem cells (ESC). Furthermore, hBSCs differentiate in vitro into cell types from all three germ layers, do not form tumors when injected in mice and show expression of cellular markers linked to the suppression of an immune response.

Additionally, a corresponding stem cell population has been identified in mouse breast milk and cross-fostering experiments have revealed that breast milk-derived cells migrate to, and integrate into, the developing organs of the cross-fostered pups. As such, it will be appreciated that BSCs, as one bioactive component of breast milk, appear to play an important role in the developing infant—irrespective of the infant's health status.

Accordingly, the nutritional compositions of the present disclosure can confer the benefits of BSC transfer from the mother to the infant by providing BSCs to an infant who cannot receive the full benefits of directly receiving breast milk from their mother's breast.

Generally, BSC isolation and subsequent culture of the BSCs such as to obtain the BSCs for use in the nutritional compositions of the present disclosure may proceed as follows:

Pump-expressed mature breast milk is obtained from a mother and is transported to the laboratory. The breast milk is then diluted with an equal volume of sterile PBS (pH 7.4, Gibco, USA) and centrifuged at 805 g for 20 min at 20° C. The fat layer and liquid part are removed with a pipette and the cell pellet is washed three times in PBS and resuspended in 7% Fetal Bovine Serum (FBS, Certified, Invitrogen, USA) in PBS (blocking buffer). The total cell concentration and viability of each sample is determined with a Neubauer hemocytometer by Trypan Blue exclusion.

Primary neonatal human fibroblasts are cultured in DMEM (Gibco) supplemented with 10% fetal bovine serum (FBS, Invitrogen) and 1% antibiotic/antimycotic (Invitrogen). For feeder culture of breast milk cells, plates are coated with 0.01% gelatine at 37° C. for 40 min. Unbound gelatine is aspirated off and washed out with PBS prior to seeding of MEFs. MEFs are maintained in DMEM (Gibco) containing 10% FBS (Invitrogen) and 1% antibiotic/antimycotic (Invitrogen). Two hours prior to plating of breast milk cells, the MEF medium is aspirated off, the plate is washed with PBS and fresh hESC medium is added. Breast milk cells are seeded in feeders in MEF-conditioned hESC medium at densities ranging 5×10⁵-5×10⁶ per 35 mm dish and incubated at 37° C. and 5% CO₂. On days 2 and 4 after plating, fresh hESC medium is added on top of the existing medium. On day 5-6, the medium is changed, and since then a daily medium change is performed. For secondary feeder culture, single colonies are individually picked and transferred to new plates in appropriate volume of fresh medium in a split ratio of 1:2. For feeder-free culture, breast milk cells are seeded in gelatine-coated or uncoated adherence plates in hESCs medium at densities ranging 5×10⁵-5×10⁶ per 35 mm dish, and incubated at 37° C. and 5% CO₂. Media changes are carried out as above. For passaging of the adherent colonies, the cells are washed once with PBS and then incubated with trypsin medium (Gibco) for 5 min at 37° C. Detached cells are collected after addition of trypsin inhibitor (Invitrogen), washed with PBS once, resuspended in fresh medium and transferred to a new plate in a split ratio of 1:3. For spheroid culture, breast milk cells are seeded in ultra-low binding plates (Co-Star) at densities ranging 5×10⁵-5×10⁶ per 35 mm dish, in MammoCult medium (Stem Cell Technologies) supplemented with 3% antibiotic/antimycotic and 2 μl/ml fungizone (Invitrogen). Spheroids are then maintained for up to 2 weeks at 37° C. and 5% CO₂ with addition of fresh MammoCult medium on top of the existing medium every 3 days. For spheroid passaging, spheroids are washed once with PBS and then incubated with trypsin medium (Gibco) for 5 min at 37° C. Dissociated cells are collected after addition of trypsin inhibitor (Invitrogen), washed with PBS once, resuspended in fresh medium and transferred to a new plate in a split ratio of 1:3.

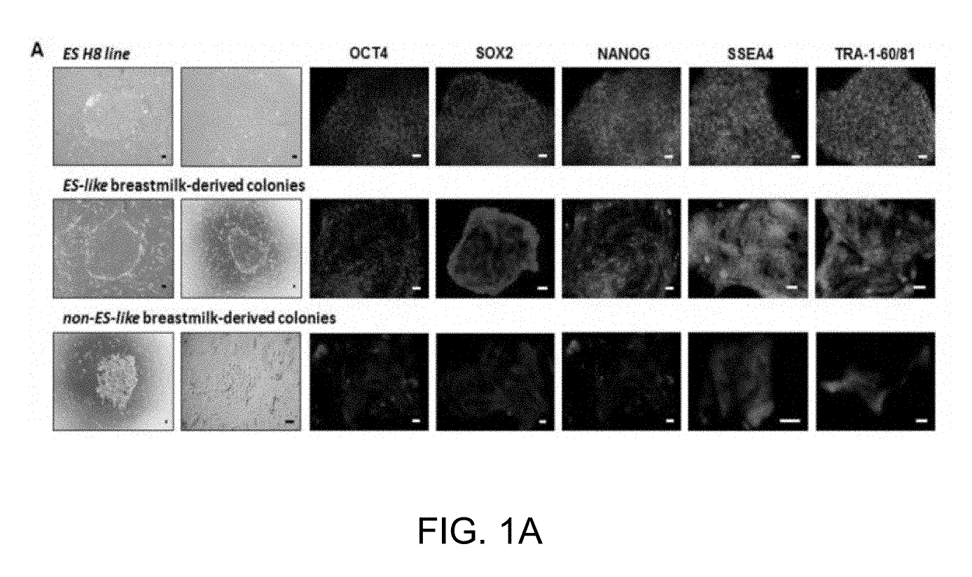

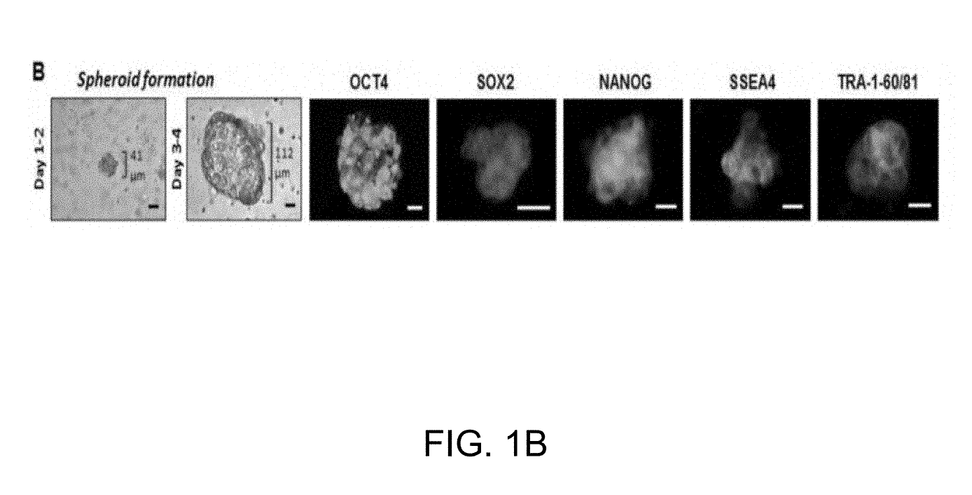

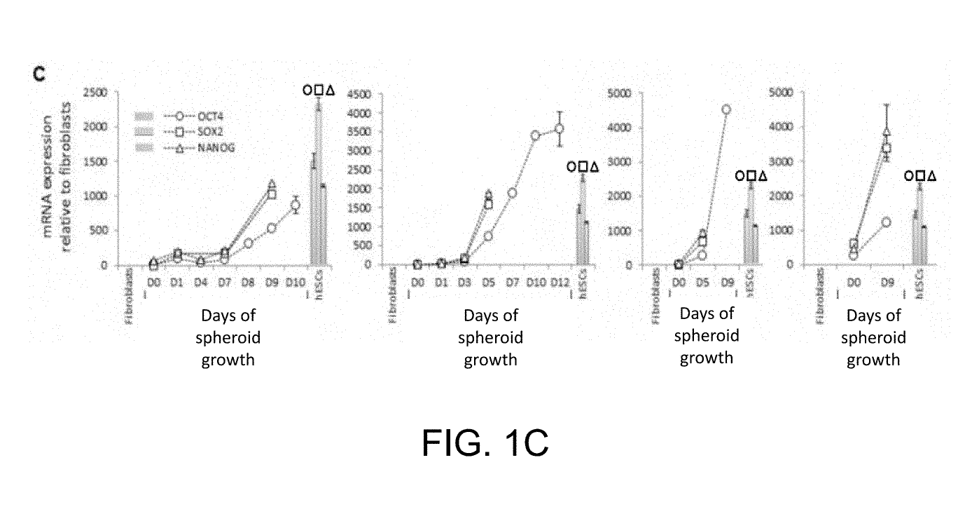

As has been reported, to examine the clonogeneicity, morphology and phenotype of hBSCs in the presence of feeder cells and to compare it with that of hESCs, cells isolated from freshly expressed breast milk are cultured in the presence of feeders in hESC medium. A rapid cellular proliferation can first be observed in suspension, during which individual cells divide and form spherical structures. Although expansion in suspension continues, within 4-7 days of plating adherent individual cells and colonies appear. The cells in suspension are removed with the first media change and the adherent colonies are allowed to expand. In this experimental set up, two distinct types of adherent colonies are observed: ES-like flat, compact encapsulated colonies with high nucleus:cytoplasm ratio, and non-ES-like colonies (FIG. 1A). The non-ES-like colonies have various morphologies, from a mesenchymal-like to an epithelial-like or mixed morphology (FIG. 1A). The formation frequency of the two colony types differs between different breast milk samples, with 68-100% (mean 90±3%, n=11) of all colonies displaying the ES-like morphology. In the breast milk samples tested, the frequency of ES-like colony forming cells ranged from 1 in 15,000 to 1 in 1,750,000 (n=11).

All ES-like hBSC colonies express Oct4, Sox2, Nanog, SSEA4, SSEA3, and Tra-1-60/Tra-1-81, with the TFs being localised primarily in the nucleus (FIG. 1A). Similarly to hESCs, spontaneous differentiation in the centre of the ES-like colonies is occasionally observed, particularly when they are allowed to expand for more than 2 weeks. Most non-ES-like colonies express these genes at very low levels, if at all. Based on TF gene expression, three distinct cell types are observed within the non-ES-like colonies: negative cells, dimly positive cells with TF expression primarily in the cytoplasm, and few smaller round weakly attached cells that are clearly positive in the nucleus (FIG. 1A). SSEA4 and Tra-1-60/Tra-1-81 are expressed at higher levels than the TFs in the non-ES-like colonies, but at lower levels than in the ES-like colonies.

ES-like colonies are passaged in secondary feeder cultures, where they generate identical colonies with ES-like morphology and phenotype. Similar colony formation characteristics are observed when breast milk cells are cultured in the absence of feeders in gelatine-coated or uncoated adhesion plates, although attachment and colony formation success is generally higher in the presence of feeders. Based on the above, and as has been previously suggested, hBSCs possess ES-like features, clonogeneicity and self-renewal properties.

As a propensity for initial expansion of hBSCs in suspension via spheroid formation (even in adhesion plates) can be observed, it has been established that 3D culture enriches for hESC gene expression in BSCs. Specifically, when examining the characteristics of breast milk cells when cultured in 3D in ultra-low binding plates breast milk cells rapidly form spheroids, which can be successfully maintained through several passages (FIG. 1B). Typically, the most rapid increase in spheroid size is observed within the first 1-4 days (FIG. 1B). The ability of spheroid formation, spheroid sizes and size increase in the course of culture varies between different breast milk samples. However, ESC gene expression in breast milk-derived spheroids can be confirmed by IF (FIG. 1B), revealing co-expression of these genes, and RT-PCR (FIG. 1B).

Interestingly, a significant upregulation of ESC genes is observed during spheroid formation equaling or sometimes exceeding the expression levels of hESCs. A time-course analysis of Oct4, Sox2 and Nanog mRNA expression from day 1 to day 12 of spheroid formation reveals a stable upregulation of these genes, which typically peaks after day 7, such as day 9, and reaches or exceeds the expression levels of hESCs (FIG. 10). Of note, variations in the extent of upregulation of ESC genes and the day which expression levels peaked were observed among different breast milk samples. Therefore, while culture of breast milk cells in suspension provides a rapid method for expansion of the hBSC population with ES-like features, the variations seen between different breast milk samples are in line with variations of the cellular composition of breast milk seen between individual mothers.

As such, it will be appreciated that expansion of hBSCs isolated from an infant's mother's breast milk and cultured in 3D spheroid culture allows for the best, maternally-matched population of BSCs to be provided and used in the second component of the nutritional compositions of the present invention.

In exemplary embodiments of the invention, the second component is concentrated breast milk. The milk has been concentrated to increase the total number of live BSCs per volume of the second component. The skilled person will appreciate that, for the purposes of the present invention, concentration of breast milk can be performed by any known method that preserves the viability of the BSCs within said breast milk. As such, concentration can, for example, be achieved by appropriate gravitational separation or ultrafiltration.

In other embodiments, the second component is a saline or otherwise suitable solution comprising BSCs previously expanded in culture as described above.

It will be understood that the total volume of the compositions of the present disclosure can be adjusted according to the infant's requirements. As indicated, the compositions are also useful for the feeding of at-risk infants and the volume of a feed composition to be fed to the infant will have to be determined based on the individual infant's development and medical history.

Generally, for the compositions of the present disclosure, the volume of the first component is larger than the volume of the second component. Typically, the ratio of first to second component may range from 100:1 to 1:1, such as, for example, 100:1, or 95:1, or 90:1, or 85:1, or 80:1, or 75:1, or 70:1, or 65:1, or 60:1, or 55:1, or 50:1, or 45:1, or 40:1, or 35:1, or 30:1, or 25:1, or 20:1, or 15:1, or 10:1, or 5:1, or 4:1, or 3:1, or 2:1, or 1:1.

While the second component may be added to BSC-deficient human breast milk of the first component in a frozen, refrigerated, powdered or thawed state, it will be appreciated that the first and second components are mixed, if desired, at a suitable time before feeding, to form the composition of the invention when in a refrigerated, thawed (room temperature) or warmed state.

In embodiments where warming is desired, a suitable warming device such as, for example, a Medela Waterless Milk Warmer™ is used. Warming can occur at any temperature that preserves the live BSCs. As for all infant feeds, warming of the composition may allow the infant to better tolerate the feed composition.

In some variations of the invention, the stem-cell deficient component of the composition that provides the majority of the nutrition is warmed prior to mixing to form the composition; and the component that comprises the BSCs is mixed with the warmed nutritional component. For example, the stem cells may be mixed into the warmed nutritional component immediately before feeding.

Due to processing of the human breast milk of the first component, such as processing for storage and handling, sterilisation, pasteurisation, refrigeration or freezing, the addition of the BSCs of the second component partially or fully replenishes the milk with respect to the BSCs.

In some embodiments, the addition of the BSCs of the second component not only replenishes but even enhances the second component with respect to BSCs.

In some embodiments, the BSCs have been obtained from the mother's own milk and have been isolated for expansion in culture prior to its addition to the first component.

Typically, the nutritional composition according to the disclosure comprises the BSCs in an amount similar or greater to the amount of BSCs found in a corresponding volume of mother's own milk prior to processing. In further embodiments, the addition of the BSCs of the second component to the processed human milk of the first component replenishes the milk with respect to the BSCs. In the personalised feed composition for a mother's infant so provided, the BSCs of the second component are BSCs isolated from the mother's own milk and expanded in 3D spheroid culture prior to addition to the first component.

It will therefore be appreciated that adding the second component to the processed human breast milk of the first component replenishes the processed human breast milk with respect to the BSCs depleted/killed during processing.

Accordingly, the present disclosure relates to the replenishment of processed human breast milk with BSCs having previously been isolated from an infant's mother's own breast milk to generate a personalised, maternally-matched feed composition for the infant.

The compositions of the present invention allow a mother to provide her own infant with a personalised feed composition comprising beneficial BSCs to optimise the health and enhance the development of her own infant, even when her own breast milk production is suboptimal.

The present disclosure also encompasses methods and processes for preparing the compositions described above.

In particular, some exemplary embodiments of the disclosure relate to methods for preparing the personalised infant feed compositions described above. Using the processes of the present invention, personalised, breast milk-based, nutritional infant feed compositions can be prepared for healthy and at-risk infants, such that appropriate nourishment of the infant is provided together with beneficial BSCs from the infant's mother's own breast milk.

In some embodiments, the nutritional compositions of the disclosure can be prepared by providing a breast milk stem cell-deficient first component providing the majority of the nutritional value to the composition and a second component comprising BSCs.

In light of the above, it will be appreciated that BSCs can be isolated, expanded and enriched. As such, the BSCs of the first component of the nutritional composition to be prepared in accordance with the present disclosure are isolated from a mother's breast milk and conveniently expanded as spheroids.

In one embodiment, the first component is processed human breast milk which displays a substantially reduced live BSC count as compared to natural breast milk. Generally, the BSCs of the natural breast milk have been completely or partially removed from the processed breast milk of the first component by sterilisation, pasteurisation, refrigeration or freezing.

Finally, the second component is added to the first component such that the nutritional composition of the present disclosure is prepared.

In some embodiments, and as indicated above, the process also comprises culturing isolated BSCs under conditions conducive to the proliferation of said BSCs such that the amount of BSCs is increased prior to adding the BSCs to the second component. Conveniently, the isolated BSCs are cultured under the described BSC spheroid culture conditions.

Additionally, the process comprises an optional step of maintaining the composition under conditions conducive to the preservation of the BSCs prior to feeding to an infant.

While both the first and second components of the composition may be stored independently under preserving conditions as described above, adding the second component to the first component as soon it has been prepared to form the composition of the disclosure is preferred.

As will be appreciated from the above, in some embodiments, the first component is processed human breast milk, such as Holder-pasteurised breast milk, and the second component comprises BSCs such that adding said second component to said first component partially or fully replenishes the processed human breast milk with respect to the BSCs.

In some embodiments, the first component of the personalised nutritional infant feed composition is again pasteurised human donor breast milk but the personalised infant feed composition comprises the BSCs in an amount similar or greater to the amount of the BCSs found in a corresponding volume of the mother's own breast milk.

In some preferred embodiments, the second component comprises BSCs expressing the ESC pluripotency transcription factors Oct4, Sox2, Nanog, Klf4, SSEA4, Tra-1-60/Tra-1-81.

It will be appreciated that the beneficial BSCs of the compositions of the present disclosure can be transferred to an infant by feeding the composition to the infant. Without wanting to be bound by theory, it is suggested that once ingested the BSCs can support the health and development of the infant. In some instances, the BSCs of the nutritional compositions of the disclosure can be incorporated into and contribute to the development of the developing organs of the neonate.

In some embodiments the methods of the present disclosure provide means to continuously prepare personalised nutritional infant feed compositions (i.e. “on demand”). In some embodiments, the compositions prepared provide non-therapeutic benefits supporting the healthy development and growth of the infant.

Thus, while the preferred embodiments of the invention are disclosed above, those skilled in the art will recognise that other and further modifications may be made thereto without departing from the spirit of the invention, and it is intended to claim all such changes and modifications as falling within the scope of the invention. Steps may be added or deleted to methods described within the scope of the present disclosure.

Additional embodiments relating to BSCs (numbered paragraphs)

1. A personalised composition for feeding an infant comprising (a) a stem-cell deficient first component providing the majority of the nutritional value to the composition, and (b) a second component comprising breast milk stem cells (BSCs).

2. The composition according to paragraph 1, wherein said BSCs have been isolated from said infant's mother's own milk.

3. The composition according to any one of paragraphs 1 or paragraph 2, wherein said BSCs have been proliferated in culture.

4. The composition according to paragraph 3, wherein the BSCs have been proliferated in BSC spheroid culture.

5. The composition according to paragraph 1, wherein said second component is said mother's own milk, which has been concentrated.

6. The composition according to paragraph 5, wherein said mother's own milk has been concentrated by ultrafiltration.

7. The composition according to any one of paragraphs 1 to 6, wherein said first component is human breast milk.

8. The composition according to paragraph 7, wherein said human breast milk has been processed.

9. The composition according to paragraph 8, wherein said human breast milk is from said mother.

10. The composition according to paragraph 8, wherein said human breast milk is not from said mother.

11. The composition according to paragraph 9 or paragraph 10, wherein said human breast milk has been processed for handling and/or storage.

12. The composition according to any one of paragraphs 10 to 11, wherein said breast milk has been frozen.

13. The composition according to any one of paragraphs 9 to 11, wherein said human breast milk has been sterilised.

14. The composition according to any one of paragraphs 9 to 11, wherein said human breast milk has been pasteurised.

15. The composition according to paragraph 10, wherein said human breast milk is human donor breast milk.

16. The composition according to any one of paragraphs 1 to 6, wherein said first component is infant formula.

17. The composition according to any one of paragraphs 1 to 16, wherein said composition comprises said BSCs in an amount similar or greater to the amount of BSCs found in a corresponding volume of said infant's mother's own unprocessed breast milk.

18. The composition according to any one of paragraphs 10 to 15 or 17, wherein said second component partially or fully replenishes or enhances said processed human breast milk with respect to BSCs depleted during processing.

19. A personalised composition for feeding an infant, wherein said composition comprises human breast milk with a substantially reduced live BSC count as compared to unprocessed breast milk but to which BSCs from the infant's mother's own breast milk are added, such that said processed human breast milk is partially or fully replenished or enhanced with respect to BSCs.

20. The composition according to paragraph 19, wherein said processed human breast milk is said mother's own pasteurised and/or previously-frozen milk.

21. The composition according to paragraph 19, wherein said processed human breast milk is pasteurised and/or previously-frozen human donor breast milk.

22. A personalised composition for feeding an infant, said composition comprising:

(a) either breast milk stem cell-deficient human breast milk or infant formula as a first component, wherein said first component provides the majority of the nutritional value to the composition; and

(b) a second component comprising BSCs isolated from said infant's mother's own breast milk.

23. A nutritional composition for feeding an at-risk infant selected from the group of preterm infants, low birth weight infants and sick infants, said composition comprising:

(a) a first breast milk stem cell-deficient component providing the majority of the nutritional value to the composition; and

(b) a second component comprising BSCs isolated from said infant's mother's own breast milk,

wherein said composition comprises said BSCs from said mother's breast milk in an amount similar or greater to the amount of said BSCs found in a corresponding volume of said mother's own unprocessed breast milk.

24. A process for preparing a personalised composition for feeding an infant, said process comprising the steps of

(a) isolating BSCs from said infant's mother's own breast milk;

(b) providing a first breast milk stem cell-deficient component, said first component providing the majority of the nutritional value to the composition;

(c) providing a second component comprising the BSCs isolated from said mother's own breast milk in step a); and

(d) adding said second component to said first component.

25. The process according to paragraph 24 further comprising the step of:

a1) culturing said isolated BSCs under conditions conducive to the proliferation of said BSCs such that the amount of BSCs is increased prior to adding said BSCs to said second component.

26. The process of paragraph 25, wherein said culturing of step al) is culturing said BSCs in BSC spheroid culture.

27. The process according to any one of paragraphs 24 to 26 further comprising the step of:

(e) maintaining said composition under conditions conducive to the preservation of said BSCs.

28. The process according to any one of paragraphs 24 to 27, wherein said first component is breast milk stem cell-deficient human breast milk and wherein said second component comprises a BSC population profile mirroring the BSC population profile of said mother's own unprocessed breast milk.

29. The process according to any one of paragraphs 24 to 28, wherein said composition comprises said BSCs in an amount similar or greater to the amount of said BSCs in a corresponding volume of said mother's own unprocessed breast milk such that adding said second component to said first component partially or fully replenishes or enhances said breast milk stem cell-deficient human breast milk with respect to said BSCs.

30. The process according to any one of paragraphs 24 to 29, wherein the breast milk stem cell-deficient human breast milk is said mother's own pasteurised and/or previously-frozen milk.

31. The process according to any one of paragraphs 24 to 29, wherein the breast milk stem cell-deficient human breast milk is pasteurised human donor breast milk.

32. The process according to any one of paragraphs 24 to 31, wherein said composition is a nutritional composition and said infant is an at-risk infant selected from the group of preterm infants, low birth weight infants and sick infants.

33. The process according to paragraph 32, wherein said infant is a preterm infant.

34. A nutritional composition when prepared according to the process of any one of paragraphs 24 to 33.

### Bacterial Aspects

Described herein are compositions for feeding an infant and methods of their production.

In particular, and as indicated above, the disclosure relates to a composition for feeding an infant comprising a first and a second component, wherein the second component comprises at least one bacterium from human breast milk or the lactating human mammary gland. The disclosure has been developed primarily as a composition for feeding a mother's own, at-risk infant such that appropriate nourishment of the preterm infant is provided together with beneficial bacteria from the infant's mother's own breast milk, even in instances where the circumstances do not allow for the infant to receive full nutrition by way of being fed the mother's own milk directly from the breast or after breast milk expression. The feed compositions of the present disclosure are therefore “personalised” feed compositions for the mother's infant.

In some instances, the circumstances that do not allow for the at-risk infant to receive the mother's own milk may be that the mother's milk supply is insufficient. In other instances, infant and mother may have to remain separated for prolonged periods of time due to, for example, medical reasons.

As indicated above, the present disclosure relates to infant feed compositions that provide both appropriate nourishment as well as beneficial bacteria to the at-risk infant.

Generally, the first component of the compositions of the disclosure comprises either processed human breast milk or infant formula and the second component comprises a live bacterium (but typically two or more different live bacteria) from human breast milk or the lactating human mammary gland.

In embodiments where the first component of the composition is made up of processed human breast milk, the breast milk generally no longer contains the milk microbiota it contained prior to its processing. The processed breast milk may be the mother's own breast milk, an individual donor's breast milk or pooled donor breast milk.

Typically, the processed breast milk of the first component is sterilised or pasteurised breast milk, or breast milk that has been frozen. When sterilised, the processed breast milk does not contain live bacteria. When pasteurised, the bacterial count of the processed breastmilk has been substantially reduced subsequent to pasteurisation. Similarly, freezing freshly-expressed mother's own breast milk may reduce the amount of live bacteria in the milk. Accordingly, upon thawing, breast milk previously-frozen for storage generally has a reduced live bacterial count.

Pasteurised breast milk for use as the first component can be prepared by any pasteurisation method known in the field.

Holder pasteurisation is a low-temperature long-time (LILT) heat treatment widely used a human milk banks. Breast milk is heat treated for 30 minutes at temperatures greater than 56° C., for example at 62.5° C.

Alternatively, ultraviolet (UV) irradiation may be used to pasteurise breast milk and UV-C pasteurisation at wavelengths between 250 and 270 nm has been shown to be an effective pasteurisation method for human breast milk (Christen et al. The Effect of UV-C Pasteurisation on Bacteriostatic Properties and Immunological Proteins of Donor Human Milk. PLOS 2013, Vol. (8):12, e85867). Further, pascalisation or high pressure processing may be used to pasteurise breast milk.

Processing of breast milk for use in the compositions of the present disclosure includes processing of the milk for handling and storage, such as handling and storage in human breast milk banks. Typically, the breast milk is sterilised or pasteurised. Alternatively, the breastmilk may be frozen for storage.

In embodiments where the first component of the composition is made up of formula, the formula has been carefully (i.e. substantially aseptically) prepared such as to avoid any bacterial contamination, which could bear the risk of bacterial infection for the at-risk infant. In some instances, the formula may be pasteurised subsequent to its initial preparation.

Notwithstanding the above, both components of the compositions of the disclosure are generally conducive to the proliferation of the bacteria of the second component. This is intended since, as indicated above, the supply of the infant's mother's own breast milk may be limited such that bacteria from the mother's own milk may only be obtained from very small volumes of the mother's own milk. As such, the bacteria to be comprised in the second component may have to be proliferated such as to provide an adequate quantity of bacteria in said final composition.

Accordingly, in some embodiments maintaining either (a) the second component prior to mixing with the first component, or (b) the mixed first and second components, under conditions conducive to the proliferation of the bacteria will allow the bacteria to proliferate such that the total number of bacterial cells in said second component and the mixed first and second components, respectively, is increased.

In some embodiments the second component is sterile water to which at least one bacterium from human breast milk or the human mammary gland has been added. Particularly, the bacterium has been obtained from a mother's own milk and the composition is for feeding the mother's own infant.

In other embodiments, the second component is processed human breast milk to which at least one bacterium from human breast milk or the human mammary gland has been added. Particularly, the bacterium has been obtained from a mother's own milk and the composition is for feeding the mother's own infant. In some embodiments the processed human breast milk of the second component is from the mother of the infant to receive the infant feed composition. In alternative embodiments the processed human breast milk is not from the mother of the infant to receive the infant feed composition, but from another lactating woman such as from a breast milk donor.

In some embodiments the bacteria have been expanded in bacterial culture before being added to the second component. This expansion typically comprises proliferation of the bacteria in specific bacterial culture media well-known in the field. For example, in some embodiments, the bacteria have been proliferated in an undefined nutrient medium comprising a carbon source such as glucose, salts, an amino acids and nitrogen source such as a beef or yeast extract, and water. Alternatively, the bacteria have been proliferated in a chemically defined medium. In some embodiments, the bacteria have been proliferated on selective medium such as to ensure predominant proliferation of Gram-positive bacteria. Selective medium for the proliferation of Gram-positive bacteria known in the field are Mannitol Salt Agar or Baird-Parker agar. Of course, the skilled person will appreciate that other bacterial culture media can be used to expand the bacteria in culture.

However, and as indicated above, in exemplary embodiments of the present disclosure, the bacteria of the second component proliferate in said second component or once the first and second components have been combined.

In exemplary embodiments of the disclosure, the second component is the infant's mother's own breast milk containing the mother's individual live microbiota. In some embodiments the second component is concentrated mother's own breast milk. The milk has been concentrated such as to increase the total number of live bacteria per volume of the second component. The skilled person will appreciate that, for the purposes of the present disclosure, concentration of breast milk can be performed by any known method that preserves the viability of the bacteria within said breast milk. As such, concentration can, for example, be achieved by gravitational separation or ultrafiltration.

In some embodiments the mother's own breast milk constitutes the second component and is maintained under conditions conducive to the proliferation of bacteria comprised in the microbiota such that the total number of bacteria in the mother's own breast milk is increased before being added to the first component. For example, the mother's own breast milk constituting the second component may be collected and may be stored under conditions conducive to the proliferation of the bacteria before being combined with the first component to form the infant feed composition.

In alternative embodiments, the mother's own breast milk constitutes the second component but is maintained under conditions that are not conducive to bacterial proliferation until it is combined with the first component. In such instances, the mixed first and second components are typically maintained under conditions conducive to the proliferation of the breast milk microbiota such that said total number of bacteria is increased.

It is well known in the field that despite the bacteriostatic properties of human breast milk, bacterial proliferation still occurs when breast milk is maintained under conditions conducive to the bacteria's proliferation. Such conditions may comprise maintaining the breast milk at temperatures between 25° C. and 37° C. for a period of time that allows for at least one duplication of the bacteria. Suitable time periods may be time periods of 30 or more minutes such as 30 minutes, 40 minutes, 50 minutes, 60 minutes, 70 minutes, 80 minutes, 90 minutes, 100 minutes, 110 minutes, 120 minutes, 130 minutes, 140 minutes, 150 minutes, 160 minutes, 170 minutes, 180 minutes, 3.5 hours, 4 hours, 4.5 hours, 5 hours, 5.5 hours, 6 hours or longer.

Furthermore, it has been shown that Holder-pasteurised breast milk has lost its natural bacteriostatic properties and is, therefore, a potent bacterial growth medium (Christen et al. The Effect of UV-C Pasteurisation on Bacteriostatic Properties and Immunological Proteins of Donor Human Milk. PLOS 2013, Vol. (8):12, e85867). As such, in some exemplary embodiments of the present disclosure, the first component of the composition of the disclosure is Holder-pasteurised human breast milk.

It will be understood that the total volume of the compositions of the present disclosure can be adjusted according to the infant's requirements. As indicated, the compositions are especially useful for the feeding of at-risk infants and the volume of a feed composition to be fed to the infant will have to be determined based on the individual infant's development and medical history.

Generally, for the compositions of the present disclosure, the volume of the first component is larger than the volume of the second component. Typically, the ratio of first to second component may range from 100:1 to 1:1.

The second component may be in a frozen, refrigerated, powdered or thawed state, as long as it has been prepared and handled such as to ensure the viability of the bacterium comprised within. Also, while the second component may be added to the processed human breast milk of the first component in a frozen, refrigerated, powdered or thawed state, it will be appreciated that the first and second component are mixed, if desired, at a suitable time, such as to form the composition of the disclosure when in a refrigerated, thawed (room temperature) or even warmed state.

In embodiments where warming is desired, a suitable warming device such as, for example, a Medela Waterless Milk Warmer™ is used. Warming can occur at any temperature that preserves or proliferates the live bacterium or different live bacteria. Warming of the composition may be useful to activate the beneficial bacteria of the composition.

Due to processing of the human breast milk of the first component, such as processing for storage and handling, sterilisation, pasteurisation or freezing, the addition of the bacterium of the second component partially or fully replenishes the donor milk with respect to the bacterium (or the two or more different bacteria).

As mentioned above, in embodiments where the composition of the disclosure comprises processed human breast milk having a substantially reduced bacterial cell count as compared to unprocessed breastmilk as the first component, the second component provides at least one live bacterium the cell count of which is substantially reduced in the processed human breast milk of the first component. Specifically, when the composition comprises sterilised, pasteurised or previously-frozen human breast milk as the first component, the second component provides at least one live bacterium the cell count of which is substantially reduced in the sterilised, pasteurised or previously-frozen human breast milk of the first component. As such, it will be appreciated that combining the second component comprising the at least one live bacterium from human breast milk or from the human lactating mammary gland partially or fully replenishes the processed human breast milk of the first component with respect to the at least one bacterium such as to form the infant feed compositions of the present disclosure.

In some embodiments, the bacterium has been obtained from the mother's own milk and has been isolated for expansion in culture prior to its addition to the first component.

Typically, the composition according to the disclosure comprises the live bacterium in an amount similar to the amount of said live bacterium found in a corresponding volume of mother's own milk prior to processing. However, in further embodiments, the addition of the two or more different live bacteria of the second component to the processed human milk of the first component replenishes the milk with respect to the bacteria. In the personalised feed composition for a mother's infant so provided, the relative proportions of the two or more bacteria substantially mirror the relative proportions of the two or more bacteria in the mother's own milk.

It will therefore be appreciated that adding the second component to the processed human breast milk of the first component replenishes the processed human breast milk with respect to the live bacterium, or the two or more different live bacteria, killed during processing.

However, the compositions of the present disclosure are not to be confused with infant feed compositions to which merely any probiotic bacterium has been added.

As indicated by the first human breast milk microbiome study, milk bacterial communities were generally complex. While three genera (Streptococcus, Staphylococcus and Serratia) represented more than 5% of the relative community abundance, eight other genera represented ≧1% of the communities observed across samples (Hunt K M, et al. PLoS ONE 2011; 6:e21313). However, among the hundreds of operational taxonomic units (OTUs) detected in each breast milk sample, only nine (Streptococcus, Staphylococcus, Serratia, Pseudomonas, Corynebacteria, Ralstonia, Propionibacterium, Sphingomonas, and Bradyrhizobiaceae) were present in every sample from every woman. While these nine “core” OTUs combined represented approximately half of the microbial community observed in each sample, their relative abundance has been shown to vary greatly between subjects and the remaining half of the community was not conserved across women. As such, the bacterial composition of human breast milk bacterial communities associated with a particular individual were often shown to be stable and highly personalised.

As such, it will be clear that the present disclosure relates to the replenishment of processed human breast milk with a live bacterium or with two or more different live bacteria having previously been identified in an infant's mother's own breast milk such as to generate a personalised feed composition for the infant.

As the compositions of the present disclosure assist in the improved feeding of at-risk infants, the compositions are formulated such as to comprise beneficial bacteria from human breast milk of the human lactating mammary gland and to minimise the presence of pathological bacteria.

The compositions of the present disclosure allow a mother to provide her own infant with a personalised feed composition comprising beneficial bacteria and tailored to optimise the health of her own infant, even when her own breast milk production is suboptimal.

The present disclosure also encompasses methods and processes for preparing the compositions described above.

In particular, some exemplary embodiments of the disclosure relate to methods for preparing the personalised infant feed compositions described above. As indicated, and without wanting to be bound by theory, the compositions of the present disclosure are particularly useful for mothers of preterm infants. Using the processes of the present disclosure, personalised breast milk-based feed compositions can be prepared for these at-risk infants, such that appropriate nourishment of the infant is provided together with beneficial bacteria from the infant's mother's own breast milk.

In some embodiments, a small amount of a mother's own milk is aseptically collected and the bacterial profile of the infant's mother's own milk is determined using culture-based and/or culture-independent methods known in the art such, as for example: Repetitive sequence-based PCR (rep-PCR); DNA Microarrays; Ribotyping; Multilocus variable number of tandem repeats analysis (MLVA); 16-S rRNA sequencing; Multilocus sequence typing (MLST); and Pulsed-field gel electrophoresis (PFGE).

Determining the bacterial profile of the mother's own unprocessed breast milk may comprise taxonomic identification of the bacteria, determining a bacterium's individual abundance within the mother's own milk as well as determining the relative proportions of different bacteria. Subsequently, the bacterial profile of the mother's own breast milk is analysed and the beneficial bacterium or bacteria with which the first component is to be replenished are identified.

In one embodiment a first component is provided. Typically, the first component is processed human breast milk which displays a substantially reduced live bacterial cell count as compared to unprocessed breastmilk. Generally, the bacteria constituting the natural breast milk microbiota have been completely or partially removed from the processed breast milk of the first component by sterilisation, pasteurisation or freezing. Bacterial colony counts of pasteurised breast milk should be zero and no bacterial growth should be detected subsequent to pasteurisation. Pasteurised breast milk for use as the first component can be prepared by any pasteurisation method known in the field.

Holder pasteurisation is a low-temperature long-time (LTLT) heat treatment widely used at human milk banks. Specifically, breast milk is heat treated for 30 minutes at temperatures greater than 56° C., for example at 62.5° C.

Alternatively, ultraviolet (UV) irradiation may be used to pasteurise breast milk and in particular UV-C pasteurisation of breast milk at wavelengths between 250 and 270 nm has been shown to be an effective pasteurisation method for human breast milk (Christen et al. The Effect of UV-C Pasteurisation on Bacteriostatic Properties and Immunological Proteins of Donor Human Milk. PLOS 2013, Vol. (8):12, e85867).

Once the bacterial profile of the mother's own milk has been determined a second component comprising the beneficial bacterium, or beneficial bacteria, with which the pasteurised human breast milk of the first component is to be replenished, is prepared.

To this end, in some preferred embodiments, the beneficial bacterium is obtained by isolation, preferably from the mother's own milk. However, as a number of bacteria, which are regularly found in mother's own milk, are also present in the mammary gland microbiota, the bacterium may also be isolated from the mother's mammary gland. Once obtained, the bacterium or the bacteria can be expanded in culture.

Finally, the second component is added to the first component provided such that the composition of the present disclosure is prepared.

In some embodiments, and as indicated above, the process also comprises maintaining the second component under conditions conducive to the proliferation of said at least one bacterium, such that the amount of said bacterium in the second component is increased prior to adding it to the first component.

Alternatively, the process comprises a step of maintaining the composition under conditions conducive to the proliferation of the at least one bacterium after the first and second components have been combined such that the amount of the bacterium or bacteria is increased prior to feeding the composition to the infant. In such embodiments, the use of Holder pasteurised breast milk may be particularly useful due to Holder-pasteurised breast milk's capacity to support bacterial proliferation.

While both the first and second components of the composition may be stored independently under preserving conditions as described above, adding the second component to the first component as soon it has been prepared to form the composition of the disclosure is preferred.

In some alternative embodiments, a sample of mother's own milk constitutes the second component of the compositions of the present disclosure.

As will be appreciated from the above, in some embodiments, the first component is processed human breast milk, such as Holder-pasteurised breast milk, and the second component comprises two or more different live bacteria at relative proportions substantially mirroring the relative proportions of said two or more bacteria in said mother's own unprocessed milk, such that adding said second component to said first component partially or fully replenishes the processed human breast milk with respect to the two or more bacteria while preserving the relative proportions of the bacteria.

In these instances, and while the relative proportions of the bacteria are preserved in the composition, the total amount of the bacteria in the composition prepared may be less than the total amount of the same bacteria present in the mother's own milk, as apparent from the bacterial profile determined. For example, the total amount of the two or more bacteria in the composition can range between 1 and 100% of the total amount of the same bacteria present in the mother's own milk, and, as such, can be about 2.5%, 5%, 7.5%, 10%, 12.5%, 15%, 17.5%, 20%, 22.5%, 25%, 30%, 32.5%, 35%, 37.5%, 40%, 42.5%, 45%, 47.5%, 50%, 52.5%, 55%, 57.5%, 60%, %, 62.5%, 65%, 67.5%, 70%, 72.5%, 75%, 77.5%, 80%, 82.5%, 85%, 87.5%, 90%, 92.5%, 95% or 97.5% of the total amount of the same bacteria present in the mother's own milk.

Alternatively, in some embodiments, the first component of the personalised infant feed composition is again pasteurised human donor breast milk but the personalised infant feed composition comprises the bacterium in an amount similar to the amount of said bacterium found in a corresponding volume of the mother's own unprocessed breast milk.

In some preferred embodiments, the second component comprises a bacterium, or two or more bacteria, selected from the group of consisting of: Enterobacteriaceae, Neisseriaceae, Comamonadaceae, Xanthomonadaceae, Moraxellaceae, Enterococcaceae, Carnobacteriaceae, Staphylococcaceae, Streptococcaceae, Bacillaceae, Leuconostocaceae, Selenomonadales, Leptotrichiaceae, Corynebacteriaceae, or more specifically, Lactobacillus acidophilus, Lactobacillus fermentum, Staphylococcus epidermidis, Streptococcus mitis, Streptococcus salivarius, Lactobacillus plantarum, Streptococcus spp., Enterococcus faecium, Lactobacillus gasseri, Enterococcus faecalis, Lactobacillus crispatus, Lactobacillus rhamnosus, Lactococcus lactis, Leuconostoc mesenteroides, Rothia mucilaginosa, Staphylococcus aureus, Staphylococcus capitis, Staphylococcus hominis, Streptococcus oris, Streptococcus parasanguis, Lactobacillus salivarius, Corynebacterium spp., Enterococcus spp., Lactobacillus spp., Peptostreptococcus spp., Staphylococcus spp., Lactobacillus reuteri, Bifidobacterium adolescentis, Bifidobacterium bifidum, Bifidobacterium breve, Bifidobacterium longum, Bifidobacterium longum ssp infantis, Kocuria rhizophila, Lactobacillus casei, Lactobacillus gastricus, Lactobacillus vaginalis, Pediococcus pentosaceus, Streptococcus lactarius, Enterococcus durans, Enterococcus hirae, Enterococcus mundtii, Lactobacillus animalis, Lactobacillus brevis, Lactobacillus helveticus, Streptococcus australis, Streptococcus gallolyticus, Streptococcus vestibularis, Leuconostoc citreum, Leuconostoc fallax, Propionibacterium acnes, Weissella cibaria, Weissella confusa, Clostridium spp., Bifidobacterium animalis, Bifidobacterium animalis ssp lactis Bifidobacterium catenolatum, Bifidobacterium spp., Enterococcus spp., Bradyrhizobiaceae, Propionibacterium spp., Pseudomonas spp., Ralstonia spp., Serratia spp., Sphingomonas spp., Stenotrophomonas spp., Citrobacter spp., Corynebacterium spp. Veillonella spp. Lysinibacillus spp., Carnobacterium spp., Granulicatella spp., Prevotella spp. Gemella spp. and Acinetobacter, or combinations thereof.

It will be appreciated that the beneficial bacteria of the compositions of the present disclosure can be transferred to an infant by feeding the composition to the infant and can then populate the gastrointestinal track of the infant. Once ingested the bacteria can improve the intestinal microbiota of the infant based on the specific breast milk microbiota of the infant's mother. Further, since the intestinal microbiota of the infant develops as the child ages, bacterial replenishment of pasteurised donor breast milk throughout development of the infant in accordance with the methods of the present disclosure provides means to continuously prepare personalised infant feed compositions, providing enhanced health benefits during development of the infant.

For example, and as indicated above, the compositions of the present disclosure can provide protection against diarrheal, respiratory diseases, can reduce the infant's risk of developing other diseases, such as diabetes or obesity in the infant, [Hunt K M, et al. PLoS ONE 2011;6:e21313., Sanz Y. Journal of Clinical Nutrition 2011; 94 (Suppl 6):2000S-5S.] and can reduce the incidence and severity of infections in the breastfed infant by a number of mechanisms such as competitive exclusion, production of antimicrobial compounds, or improvement of the intestinal barrier function by increasing mucine production and reducing intestinal permeability.

Thus, while there has been described what are believed to be the preferred embodiments of the disclosure, those skilled in the art will recognise that other and further modifications may be made thereto without departing from the spirit of the disclosure, and it is intended to claim all such changes and modifications as falling within the scope of the disclosure. Steps may be added or deleted to methods described within the scope of the present disclosure.

Additional embodiments relating to bacterium (numbered paragraphs)

1. A composition for feeding an infant, said composition comprising a first component, said first component providing the majority of the nutritional value to the composition, and a second component, said second component comprising at least one bacterium, wherein said bacterium is a live bacterium from said infant's mother's own milk.

2. The composition according to paragraph 1, wherein said composition is a personalised feed composition for said infant.

3. The composition according to paragraph 2, wherein said mother's own milk supply is not sufficient.

4. The composition according to any one of paragraphs 1 to 3, wherein said first and second components are conducive to the continued proliferation of said live bacterium.

5. The composition according to any one of paragraphs 1 to 4, wherein said bacterium has been proliferated in culture and has been added to said second component.

6. The composition according to any one of paragraphs 1 to 5, wherein said second component is mother's own unprocessed milk.

7. The composition according to any one of paragraphs 1 to 5, wherein said second component is mother's own milk, which has been concentrated.

8. The composition according to paragraph 7, wherein said mother's own milk has been concentrated by ultrafiltration.

9. The composition according to any one of paragraphs 1 to 8, wherein said first component is human breast milk.

10. The composition according to paragraph 9, wherein said human breast milk has been processed.

11. The composition according to paragraph 10, wherein said human breast milk is from said mother.

12. The composition according to paragraph 10, wherein said human breast milk is not from said mother.

13. The composition according to paragraph 11 or paragraph 12, wherein said human breast milk has been processed for handling and/or storage.

14. The composition according to any one of paragraphs 11 to 13, wherein said breast milk has been frozen.

15. The composition according to paragraph 11 or paragraph 12, wherein said human breast milk has been sterilised.

16. The composition according to paragraph 11 or paragraph 12, wherein said human breast milk has been pasteurised.

17. The composition according to paragraph 11, wherein said human breast milk is said mother's own pasteurised milk.

18. The composition according to paragraph 12, wherein said human breast milk is pasteurised human donor breast milk.

19. The composition according to any one of paragraphs 1 to 8, wherein said first component is infant formula.

20. The composition according to any one of paragraphs 1 to 19, wherein said composition comprises said bacterium in an amount similar to the amount of said bacterium found in a corresponding volume of said mother's own unprocessed breast milk.

21. The composition according to any one of the preceding paragraphs, wherein said second component comprises two or more different live bacteria.

22. The composition according to paragraph 21, wherein the relative proportions of said two or more bacteria in said composition substantially mirror the relative proportions of said two or more bacteria in said mother's own unprocessed milk.

23. The composition according to any one of paragraphs 10 to 18 or 20 to 22, wherein said second component partially or fully replenishes said processed human breast milk with respect to said bacterium or said two or more bacteria killed during processing.

24. The composition according to any one of the preceding paragraphs, wherein said infant is an at-risk infant selected from the group of preterm infants, low birth weight infants and sick infants.

25. The composition according to paragraph 24, wherein said infant is a preterm infant.

26. A personalised feed composition for a preterm infant, wherein said composition comprises processed human breast milk with a substantially reduced live bacterial cell count as compared to unprocessed breast milk but to which at least one live bacterium from the infant's mother's own breast milk is added, such that said processed human breast milk is partially or fully replenished with respect to the at least one live bacterium.

27. The composition according to paragraph 26, wherein said processed human breast milk is said mother's own pasteurised and/or previously-frozen milk.

28. The composition according to paragraph 26, wherein said processed human breast milk is pasteurised human donor breast milk.

29. A personalised feed composition for feeding an infant, said composition comprising:

(a) either processed human breast milk or infant formula as a first component, wherein said first component provides the majority of the nutritional value to the composition; and

(b) the infant's mother's own unprocessed breast milk as a second component, wherein said second component provides live bacteria of the mother's own breast milk microbiota to the composition.

30. A composition for feeding an at-risk infant selected from the group of preterm infants, low birth weight infants and sick infants, said composition comprising:

(a) a first component providing the majority of the nutritional value to the composition; and

(b) a second component providing at least one live bacterium, preferably two or more live bacteria, from said infant's mother's breast milk microbiota to the composition,

wherein at least the first component is conducive to the proliferation of said at least one live bacterium, preferably two or more live bacteria, such that, at the time of being fed to said infant, said composition comprises said at least one live bacterium, preferably two or more live bacteria, from said mother's breast milk microbiota in an amount similar to the amount of said at least one live bacterium, preferably two or more live bacteria, found in a corresponding volume of said mother's own unprocessed breast milk.

31. A process for preparing a personalised infant feed composition, said process comprising the steps of

a) determining the bacterial profile of an infant's mother's own unprocessed breast milk;

b) providing a first component, said first component providing the majority of the nutritional value to the composition;

c) providing a second component comprising at least one live bacterium determined as being present in said mother's own milk in step a); and

d) adding said second component to said first component.

32. The process according to paragraph 31 further comprising the step of:

c1) maintaining said second component under conditions conducive to the proliferation of said at least one bacterium such that the amount of said bacterium is increased prior to adding said second component to said first component in step d).

33. The process according to paragraph 31 further comprising the step of:

e) maintaining said composition under conditions conducive to the proliferation of said at least one bacterium such that the amount of said bacterium is increased prior to feeding of said composition to said infant.

34. The process according to any one of paragraphs 31 to 33, wherein said first component is processed human breast milk and wherein said second component comprises two or more different live bacteria at relative proportions substantially mirroring the relative proportions of said two or more bacteria in said mother's own unprocessed breast milk such that adding said second component to said first component partially or fully replenishes said processed human breast milk with respect to said two or more bacteria.

35. The process according to any one of paragraphs 31 to 33, wherein said composition comprises said bacterium in an amount similar to the amount of said bacterium found in a corresponding volume of said mother's own unprocessed breast milk.

36. The process according to any one of paragraphs 31 to 35, wherein the processed human breast milk is said mother's own pasteurised and/or previously-frozen milk.

37. The process according to any one of paragraphs 31 to 5, wherein the processed human breast milk is pasteurised human donor breast milk.

38. The process according to any one of paragraphs 31 to 37, wherein said infant is an at-risk infant selected from the group of preterm infants, low birth weight infants and sick infants.

39. The process according to paragraph 38, wherein said infant is a preterm infant.

40. A composition when prepared according to the process of any one of paragraphs 31 to 39.

41. A process of replenishing the live bacterial cell count of at least one live bacterium in processed human breast milk, wherein said processed human breast milk has a substantially reduced live bacterial cell count as compared to unprocessed breast milk, to produce a personalised feed composition for a preterm infant, said process comprising the steps of:

a) obtaining said at least one live bacterium from said infant's mother's own breast milk or from the mother's lactating mammary gland;

b) adding an amount of said at least one live bacterium to said processed breast milk to obtain a mixture; and

c) maintaining said mixture under conditions conducive to the proliferation of said at least one live bacterium,

such that after step c), said composition comprises an amount of said at least one live bacterium that is greater than the amount of said at least one live bacterium added at step b).

42. The process according to paragraph 41, wherein said amount of said at least one live bacterium in said composition is similar to the amount of said at least one live bacterium found in a corresponding volume of said mother's own breast milk prior to processing.

43. The process according to paragraph 41, wherein said processed human breast milk is replenished with two or more different live bacteria.

44. The process according to any one of paragraphs 41 to 43, wherein said processing is selected from: processing human breast milk for handling and storage; sterilisation; and pasteurisation.

45. The process according to any one of paragraphs 41 to 44, wherein the processed human breast milk is said mother's own pasteurised and/or previously-frozen breast milk.

46. The process according to any one of paragraphs 41 to 44, wherein the processed human breast milk is pasteurised human donor breast milk.

### Non-Cellular Aspects

An additional aspect of the invention pertains to improving a nutritional composition for infants by adding to the nutritional composition one or more fortifying, non-cellular organic components that are present in human milk, or that are suitable homologs for what is present in human milk.

In this context, “non-cellular” refers to components that are present in human milk after maternal or bacterial cells have been removed (e.g., by filtration or centrifugation). Thus, “non-cellular” includes components such as proteins, carbohydrates, and lipids, and other organic molecules that have been produced by cells of the mother or cells in fresh milk.

In some embodiments, the nutritional composition is a feed or food comprised of human breast milk, including donor breast milk. In some variations, the human breast milk has been frozen, pasteurized, and/or otherwise treated or handled in a manner that reduces the amount of, or the activity of, a non-cellular organic component naturally found in fresh human milk.

Pasteurization and other techniques are effective in reducing the microbiological load of human milk, making the milk safer in contexts where it will be stored before consumption and/or donated. Indeed, the use of Holder pasteurization to treat raw human milk to produce donor milk has become routine in the human milk banking industry and is recognised as international best practice (Hartmann et al., “Best practice guidelines for the operation of a donor human milk bank in Australian NICU,” Early Human Development, 83: 667-73 (2007)). However, pasteurization or other microbicidal processes also have the potential to significantly affect the nutritional and protective (e.g., anti-pathogenic) properties of the milk. (See de Oliveira et al., “Impact of pasteurization of human milk on preterm newborn in vitro digestion: Gastrointestinal disintegration, lipolysis and proteolysis.” Food Chemistry, 2016, 211, 171-179.) The reduction of microbiotic and other nutritional and protective properties of the donor milk can render the milk difficult for the infant to digest, which in turn can make the infant more susceptible to infection or other developmental and health problems.

In particular, Holder pasteurization can decrease lipase activity (Henderson et al., “Effect of pasteurization on long chain polyunsaturated fatty acid levels and enzyme activities of human milk.” J Pediatr, 1998, 132, 876-878) which can result in an altered pattern of released fatty acids in infants fed donor milk in comparison to raw milk which, in turn, can affect the antibacterial function of the fatty acids as well as their accumulation in to developing tissues, e.g., brain and liver (de Oliveira et al., 2016). Furthermore, the reduction in activity of lactoferrin and haptocorrin can result in decreased benefits to the infant (Lönnerdal, “Bioactive Protein in human milk: Health, Nutrition and implications for infants formulas.” Journal of Pediatrics, 2016, 173, S4-S9; and de Oliveira et al., 2016). Indeed, de Oliveira (2016) suggest that the reduced intake of these and potentially other components by the preterm infant may limit the optimal development of the infant due to the important role these compounds play in the prevention of infection and inflammation in the infant's gut and the promotion of a favourable microbiota. However, one must still be clear in acknowledging the benefits of Holder pasteurized milk over infant formula.

### Classes and Examples of Non-Cellular Organic Supplements

Particularly contemplated in this aspect of the invention is the restoration of non-cellular organic components of fresh mother's milk that have putative function in the infant beyond nutritive function. For example, proteins and lipids in mother's milk may have functions relating to immunomodulation; digestion; vitamin/mineral bioavailability, and the like, so long as they are not denatured or degraded from their active forms.

All varieties of non-cellular organic components are contemplated, including proteins, carboydrates, fats and lipids, sterols, and vitamins. In many variations, the non-cellular organic component is a protein or polypeptide. Exemplary proteins include proteins with immunoprotective properties, such as anti-bacterial or anti-viral properties (e.g., lysozyme; peroxidase, lactoferrin, fibronectin); proteins that improve bioavailability of nutrients, including digestive enzymes and cofactors (e.g., glutathione peroxidase; β-glucoronidase); and proteins that bind to other proteins, carbohydrates, lipids (including mucins), vitamins, and minerals and alter the characteristics of the nutritional composition.

In some variations, the non-cellular organic component is a digestive enzyme. Examples of enzymes that are present in fresh mother's milk include amylases, proteases (e.g., trypsin), antiproteases, peroxidases; sulfhydryl oxidase; alkaline phosphatase; and lipases, for example.

In some variations, the digestive enzyme is a lipase. Lipases are involved in digestion and transport of lipids in mammalian and other organisms, and are found in human milk. For instance, lipases catalyse conversion of triglycerides into di- and mono-glycerides and free fatty acids, which are used by the developing infant for energy, immunology, and tissue development, including brain and CNS development.

Exemplary lipases relevant to infant nutrient bioavailability include gastric lipase and bile-salt dependent lipase or bile salt stimulated lipase (BSSL, also known as carboxyl ester lipase (CEL). An exemplary amino acid sequence and protein characterization can be found at uniprot.org at UniProtKB—P19835 (CEL_HUMAN), incorporated herein by reference.

In some variations, the non-cellular organic component is a vitamin binding protein, such as Haptocorrin. Haptocorrin, also known as transcobalamin-1 (HC, TC-1, TCN1) or cobalophilin, is a vitamin B₁₂ binding protein found in high concentration in breast milk, believed to protect the vitamin from stomach acid. In addition to its functions relating to vitamin B₁₂ transport and release, haptocorrin exhibits antibacterial activity. The amino acid sequence and other structural information about haptocorrin can be found at uniprot.org at UniProtKB—P20061 (TC01_HUMAN) and NCBI Gene ID 6947, both incorporated herein by reference.

In some variation, the non-cellular organic component is an immunomodulatory protein such as lactoferrin. Lactoferrin, also known as lactotransferrin (LTF) is an iron-binding- and nucleic acid binding protein that exhibits bacteriostatic, bactericidal, and fungicidal activities. The protein is present in human milk and its concentration varies over time, higher in colostrum than mature milk. It may have a role in iron metabolism, operating through a lactoferrin receptor expressed in some cells. The amino acid and other structural information about lactoferrin can be found at uniprot.org at UniProtKB—P02788 (TRFL_HUMAN), incorporated herein by reference.

Other classes of molecules can include, for example, oligosaccharides, immunoglobulins, hormones (e.g., thyroxine; triiodothyronine, cortisol, progesterone, pregnane-3-(α)20(β)-diol, estrogens), growth factors (e.g., EGF, insulin, IFG-1, NGF, TGFα, gastrin, neurotensin, somatostatin, growth hormone, prolactin), minerals or lipids. The lipids may be from various classes including, but not limited to, sphingolipids, phospholipids and triacylglycerols.

### Assaying to Measure Non-Cellular Organic Components

Some aspects of the invention involve assaying a sample of a milk-based nutrient composition or food to measure the quantity or activity of one or more non-cellular organic components. In some variations, a measurement below a selected threshold value indicates a deficiency in the component.

Exemplary threshold levels are selected based on measurements from fresh (recently expressed, never frozen, never pasteurized, and not subjected to harsh manipulation or temperature changes) breast milk, preferably fresh breast milk from the mother of the infant to be fed. Alternatively, average measurements can be taken from fresh milk from mothers with similar characteristics as the mother of the infant to be fed. (Exemplary characteristics to consider include maternal age, race/ethnicity (as self-identified by the mother), and infant age.) When an average measurement is employed, a deficiency in an organic component can be identified using statistical tools, e.g., 0.5, 1, 1.5, or 2 standard deviations below a mean measurement. A deficiency also can be identified as a percent below an average measurement of the component in fresh milk, e.g., 10%, 15%, 20%, 25%, 30%, 35%, 40%, 45%, 50%, 60%, 70%, 75%, 90% 95%, or more, below a reference measurement; or a percentage of the mean measurement, e.g., less than or equal to 1%, 5%, 10%, 15%, 20%, 25%, 30%, 35%, 40%, 45%, 50%, 60%, 70%, 75%, 90% of a target/mean measurement.

The measurements in question can be measurements of concentration of a component in the food; and/or measurements of a relevant biological activity of the organic component. (Some organic components, e.g., enzymes, may remain present in a food composition, but inactive, e.g., in a denatured form.)

Concentration of a component can be measured, for example, using an affinity assay. Exemplary affinity reagents include antibodies with specificity for a component; receptors that have high binding affinities and selectivity for a component; natural or artificial substrates with high binding affinity for a component; and/or natural or artificial binding partners for a component. Typically, a label or other indicator is used to provide a quantitative measurement of binding between the affinity reagent and the organic component. In some variations, the concentration assay is in the form of an enzyme-linked immunosorbent assay (ELISA), where an antibody for the organic component is linked to an enzyme, and an enzymatic substrate is added that produces a detectable signal, e.g., a color change, when modified by the enzyme.

Exemplary lactoferrin assays are described in Kane et al., “Fecal lactoferrin is a sensitive and specific marker in identifying intestinal inflammation.” Am J Gastroenterol. 2003 June; 98(6):1309-14. Commercial assay materials are available from, e.g., http [colon-slash-slash] www.techlab.com/lactoferrin/ and http [colon-slash-slash] www.abcam.com/human-lactoferrin-elisa-kit-h1f2-ab108882.html.

An assay for cobalamin is described in Ulleland et al., “Direct assay for cobalamin bound to transcobalamin (holo-transcobalamin) in serum.” Clin Chem. 2002 March; 48(3):526-32, incorporated herein by reference. Haptocorrin antibody kits are commercially available.

Relevant biological activity includes any activity that a component exhibits or is believed to exhibit in fresh human milk, before or after ingestion, for the benefit of a human infant. For instance, if the component is a digestive enzyme such as a lipase, then an assay to measure lipase activity toward a lipid substrate—preferably a lipid substrate found in human breast milk—is preferred. In general, enzyme assays involve a substrate, and an indicator, such as a detectable label, to quantitatively measure disappearance of the substrate or emergence of an enzymatic product from alteration or breakdown of the substrate. Exemplary lipase assays are described in Iverson et al., “Milk lipid digestion in the neonatal dog: the combined actions of gastric and bile salt simulated lipases,” Biochim. Biophs Acta 1991; 1083: 109-19; O'Connor and Cleverly, “Fourier-transform infrared assay of bile salt-stimulated lipase activity in reversed micelles,” J. Chem. Technol. Biotechnol. 1994 November; 61(3):209-14; Blackberg and Hernell (1981) Eur. J. Biochem., 116: 221-225; Hernell and Olivercrona, “Human milk lipases,” J. Lipid Research 15: 367 (1974); Blackberg et al., “On the source of bile salt-stimulated lipase in human milk: a study based on serum concentrations as determined by sandwich enzyme-linked immunosorbent assay technique.” J Pediatr Gastroenterol Nutr. 1985 June; 4(3):441-5; all incorporated herein in their entirety.

If the component exhibits a binding activity, such as iron binding activity of lactoferrin or B₁₂ binding of haptocorrin, then an assay to measure activity would include a substrate binding assay.

Suitable assays are scalable to small size to permit analysis of small samples, e.g., at the millilitre or microliter scale. Likewise, suitable assays include assays that can be performed rapidly, to permit supplementation of a food quickly for feeding to the infant.

Suitable bioanalytical assays include, but are not limited to, immunoassays; electrochemical biosensing assays; microscopy assays; flow cytometry; and colorimetric assays. (See, e.g., Vashist et al., Anal. Bioanal Chem (DOI 10.1007/s00216-013-7473-1), published online 28 Nov. 2013, and as Anal Bioanal Chem. 2014 May; 406(14):3263-77, incorporated herein by reference in its entirety.

### Assay-Free Replenishment of Non-Cellular Organics

The effect of pasteurization, e.g., Holder pasteurization, or other manipulations on the concentration or activity can be documented from measurements taken from multiple samples of colostrum or milk that have been subjected to the pasteurizations/manipulations. Accordingly, in some variations, the pasteurized feed composition can be supplemented with an amount of a non-cellular organic component that is estimated to be needed to replace deficiency, without performing a custom assay on an individual milk sample. The effects of Holder pasteurization has been described, for example, in Peila et al., “Effects of Holder pasteurization on the protein profile of human milk,” Italian J. Pediatrics, (2016): 42: 36; and Carcia-Lara et al., “Effect of Holder pasteurization and frozen storage on macronutrients and energy content of breast milk.” J Pediatr Gastroenterol Nutr. 2013 September; 57(3):377-82.; and Baro et al., “Effect of two pasteurization methods on the protein content of human milk.” Front Biosci (Elite Ed). 2011 Jun. 1; 3:818-29.; all incorporated herein by reference.

Exemplary data on the content of human milk can be found in the following documents, incorporate herein by reference: Yin and Yang, “An on-line database for human milk composition in China.” Asia Pac J Clin Nutr. 2016 December; 25(4):818-825. doi: 10.6133/apjcn.092015.47; Gidrewicz and Fenton, “A systematic review and meta-analysis of the nutrient content of preterm and term breast milk.” BMC Pediatr. 2014 Aug. 30; 14:216. doi: 10.1186/1471-2431-14-216; Lonnerdal et al., “Longitudinal evolution of true protein, amino acids and bioactive proteins in breast milk: a developmental perspective.” J Nutr Biochem. 2016 Jun. 21; 41:1-11. doi: 10.1016/j.jnutbio.2016.06.001. [Epub ahead of print]; and Ballard and Morrow, “Human milk composition: nutrients and bioactive factors.” Pediatr Clin North Am. 2013 February; 60(1):49-74. doi: 10.1016/j.pcl.2012.10.002.

### Replacement of Non-Cellular Organics With Non-Cellular Supplements

In some variations of the invention, non-cellular organic components are supplemented into a nutrient feed in the form of a non-cellular composition.

In some embodiments, the non-cellular organics are purified from a human or animal source. For example, desired protein components can be isolated by antibody other affinity purification from fresh human milk, or non-human mammalian milk, or from animal tissue. Fresh human milk, especially if available from the biological mother of the infant, is a preferred source. In some variations, the fresh milk is concentrated to achieve a desired concentration of the organic component with a smaller volume dilution of the original food. In some variations, the addition of human milk products synthesised by functional human mammary epithelial cells in culture can provide the needed improvement. Another source for the improvement of the feed could be recombinant human milk products derived from cell culture or other various sources, e.g. rice. See, e.g., Lonnerdal, (2002) Expression of Human Milk Proteins in Plants, J. Amer. College of Nutrition, 21: sup3, 218S-221S, incorporated herein by reference in its entirety.

Various chromatographic and other separation techniques can be employed for the filtration.

In some embodiments, the non-cellular organics are recombinantly expressed and purified. For instance, a gene or cDNA encoding the protein of interest is transformed or transfected into a suitable host cell, which can be a prokaryotic cell, an animal cell line, a plant cell line, or a fungal cell line. The recombination protein is purified and isolated under conditions that preserve the protein's biological activity, and formulated for addition to a human feed composition. All human protein components of mother's milk can be expressed and sourced in this manner. Recombinant production and assaying of human bile salt simulated lipase is described in Hansson et al., “Recombinant Human Milk Bile Salt-stimulated Lipase,” J. Biol. Chem. 268(35): 26692-26698, incorporated herein by reference. Recombinant production of lactoferrin is described in Hwang et al. “CHO expressed recombinant human lactoferrin as an adjuvant for BCG.” Int J Immunopathol Pharmacol 2015; 28: 452e68, incorporated herein by reference. Recombinant production of human haptocorrin, and Haptocorrin assays, are described in Furger et al., “Comparison of Recombiant Human Haptocorrin Expressed in Human Embryonic Kidney Cells and Native Haptocorrin,” PLoS ONE 7(5): e37421. doi:10.1371/journal.pone.0037421, available at http [colon-slash-slash] dx.doi.org/10.1371/journal.pone.0037421, incorporated herein by reference in its entirety.

Lipid organics can be isolated from human breast milk or compounds synthesised by isolated human mammary epithelial cells .

In some variations, the component is added in an amount effective to approximate the amount of the active component that is present in fresh human breast milk, .e.g, 75-125%, 80-120%, 85%-115%, 90%-110%, 95%-105%, or about 100% of the amount present in fresh human breast milk. The reference human breast milk is preferably the milk of the mother of the infant who will receive the supplemented food product. The reference human breast milk also could be based on measurements from other mother's milk, as described above.

In some variations, the component is added and mixed gently with the food just prior to its use as food. In some variations, the addition occurs directly in a feeding device used to feed an infant.

Replacement of non-cellular organics with cellular supplements

In another variation, non-cellular organic components of a nutrient composition, such as pasteurized human milk, are replaced by add a portion of fresh mother's own milk to donor milk prior to delivery to the infant. In this context, “fresh” is meant to refer to milk that was recently expressed and has not been subjected to conditions, such as pasteurization, freezing, or simply the passage of time, for example) that would cause decomposition or deactivation of the desired organic components. This mother's milk supplementation would allow for the re-establishment of the mother's microbiota whilst adding functional human milk bioactive components back into the donor milk to counter-act those negative outcomes mentioned above. Suitable portions can include any portion available from the mother from 1% up to and including, for example, 99% of the feed. Every integer percentage is contemplated, e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99%.

The selected percentage will vary depending on the amount of the desired component that is present in the mother's milk and the concentration desired to be achieved.

Where cellular components of the fresh mother's milk will express and secrete a non-cellular component of interest, the corresponding volume of fresh mother's milk can be reduced. Fresh milk, including fresh milk that has not been refrigerated for a long time, contains a high cellular load. Prior to cell death (by apoptosis or other processes), these cells can continue to add enzymes, proteins, or other organic components into solution. which could add nutritive digestive components to a donor milk base when fresh mother's milk is added. The digestive components are leveraged according to the present invention to repopulate certain bioactive components in the donor milk.

The composition of breast milk is dynamic, and the precise constituents for each individual vary at any given time. Therefore, the amount of digestive components needed to form an improved digestible feed using a donor milk base can vary for each feed, as the breast milk fluid varies based on the health of the mother and baby as well as the mother's personal biochemistry. In fact, the mother's personal biochemistry can vary constantly due to diet, medications, and health status. Accordingly, in some variations, fresh mother's milk is assayed prior to either its use as a supplement to another nutritive composition, or to determine if a particular nutritive supplement needs to be added to the milk.

### Iterative Testing and Adjustment Process.

In some variations, the food adjustment process is an iterative one.

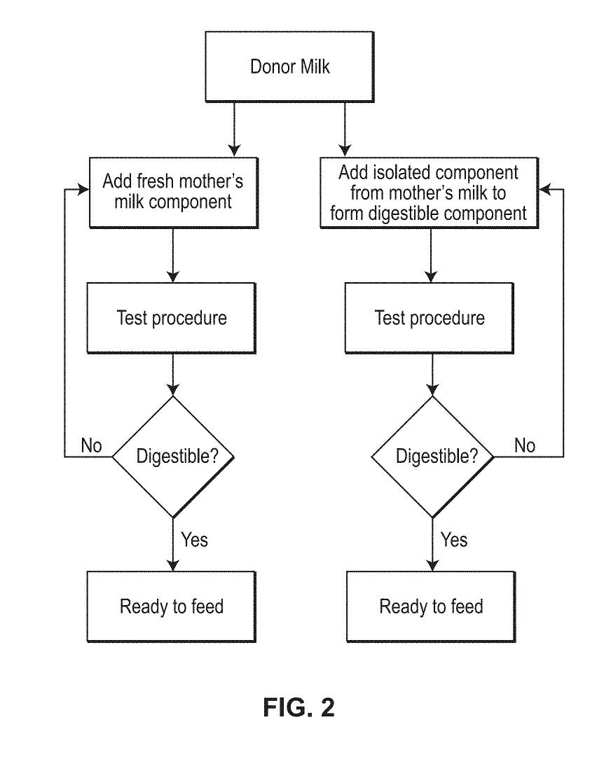

As set forth in FIG. 2, a process that tests the level of digestive components in a feed, formed using a donor milk base with digestive components added, can provide helpful information about the digestible status of the improved feed. The process tests whether the feed should be modified to improve the digestibility of the feed. As a result, changes to the feed can be made based on the test results to adjust the digestive components that improve digestion. For example, additional fresh milk might be added, if available, and the feed can undergo a subsequent retest to determine digestibility. Alternatively, individual digestive components, such as lipase, lactoferrin, haptocorrin, or other suitable nutritive components, could be added to the feed and a retest performed in order to check whether the feed contains a desired level of digestible components. The individual digestive components can be isolated from a mother's fresh milk, or manufactured to provide a suitable substitute if mother's fresh milk is unavailable. Alternatively, concentrated mother's fresh milk can be added to the feed, once tested, where multiple components are tested and found to be below desired levels for digestibility, in order to minimize the change in the ratio of the dilute (fresh mother's milk).

Yet another option is to add individual digestive components to mimic levels of the individual components expected from healthy mother's fresh milk to form an improved digestible feed, particularly when mother's fresh milk is unavailable, prior to the initial testing of the improved feed, Further supplementation can be determined based on the outcome of the testing. Moreover, individual digestive component levels can further be defined to address a specific medical need of the infant. For example, if the infant has an infection or poor digestion, then individual components can be tailored and tested to meet the individual infant's medical needs. In some circumstances, it may be beneficial to increase the amount of an active component above that which is found in fresh human breast milk, to a level that is therapeutic or prophylactive for an infant with poor digestion, infection, or other difficulty.

Where the enzymatic activity of the improved feed does not improve by the initial addition of the digestive components (in any suitable form) then key digestive components, lactoferrin haptocorrin and lipase can be extracted from the mother's milk and added to the feed prior to retesting. Additional enzymes and immune factors can further be added to the improved digestible feed formed in accordance with the process of FIG. 2, as desired, to address the health needs of the infant.

The improved process combines whole mother's fresh milk with pasteurized donor milk to allow the combined mixture to regain the microbiological, bioactivity and nutrient levels associated with digestible mother's milk. This process can provide suitable volumes of human milk that would allow for the re-establishment of the mother's microbiota whilst adding functional human milk bioactive components, including digestive components, into the donor milk to remedy the decrease in bioactivity of critical components during the holder pasteurization process as well as address a desired level of digestive components in the resulting feed.

In accordance with the principles herein, promotion of microbiota as well as improved digestibility of infant feed can be achieved and verified.

### Devices and Systems for Analysis and Feeding

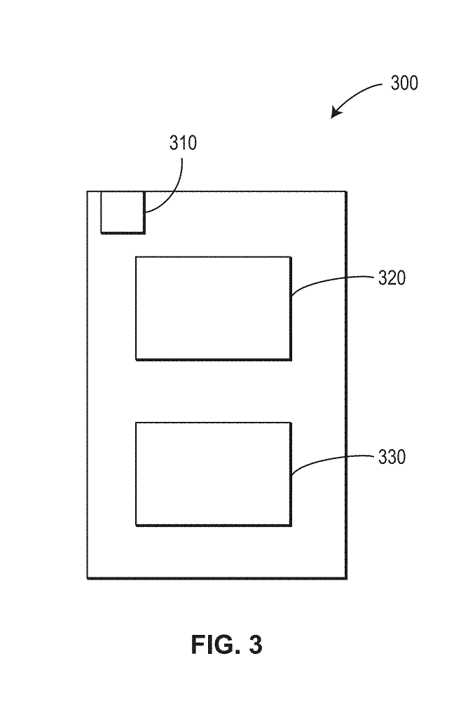

FIG. 3 illustrates a system constructed in accordance with the principles of the present disclosure shown generally at 300. The system includes a receptacle 310 capable of inputting a feeding device containing digestible feed, or receiving digestible feed directly for testing, which may be referred to as a milk chamber. The receptacle 310 is operatively connected, either directly or indirectly, to a suitable testing component 320, such as an imaging device and software, for example, or other suitable testing device, for determining the concentration of digestible components in the feed. In some variations, the testing device may include components such as one or more reagent chambers for holding reagents such as antibodies and/or substrates and/or buffers for measuring organic components in the milk/feed composition; and a detection tool for providing a quantitative or quantifiable reading from a measurement reaction. In some variations, the detection tool may be a light beam of fixed wavelength and/or a detector for detecting color, light intensity, absorption, or other reaction indicia.

In some variations, the system includes one or more reaction chambers that are in which reagents and milk/feed are mixed to measure an organic component of interest. In some variations, the reaction chamber is the same as the milk chamber or reagent chamber.

The receptacle 310 can be further operably connected, either directly or indirectly, to a suitable feeding component 330. Examples of suitable feeding components 330 include, but are not limited to, enteral feeding pumps, syringes, bottles, and breast pump systems, or any other suitable feeding component. In systems where the feeding device can be received by the receptacle 310, further connection to suitable feeding components 330 may not be necessary, depending on the configuration of the system.

In systems in which reagents are used to facilitate the measurement/testing, it is desirable to draw a small sample from the milk/feed for testing in a receptacle/chamber that is distinct from the milk/feed to be used in the feeding component.

In some variations, the system includes one or more supplement chambers operably connected to the feeding component 330. When a measurement/test indicates that the quantity/activity of a tested organic component is deficient, then a measured quantity of that component can be delivered from the supplement chamber to the feeding component 330 for admixture with the milk/feed.

Additional components for the system can also include manual or automatic switches reactive to a test outcome indicating that the digestible feed contains the desired levels of digestive components, or contains a deficient amount of the component. To this end, the system can further provide components for interacting with a processor to set the desired levels for the digestible components for the testing component 320 based on predetermined needs of an individual infant. The system can further include receptacles not shown) for individual digestive components, and automation components for automating the addition of the digestive components based on signals received from the testing component 320.

1. A method of preparing a milk-based food for a human infant comprising:
(a) assaying a sample of a feed, the feed comprising human breast milk, to measure the quantity or activity of at least one non-cellular organic component(s);
(b) identifying a deficiency in the quantity or activity of at least one of the at least one non-cellular organic component(s) in the feed sample; and
(c) supplementing the feed with one or more of: (1) living cells that produce a non-cellular organic component identified as being deficient in (b); (2) a quantity of said non-cellular organic component in cell-free, biologically active form; and (3) unpasteurized, unfrozen human breast milk that contains (1) or (2), to reduce the deficiency identified in (b).

2. (canceled)

3. A method of preparing a milk-based food for a human infant comprising:
(a) providing a feed that comprises pasteurized human breast milk;
(b) supplementing the feed with one or more of: (1) living cells that produce a non-cellular organic component of human breast milk that is destroyed or inactivated by pasteurization; (2) a quantity of said non-cellular organic component in cell-free, biologically active form; and (3) unpasteurized, unfrozen human breast milk that contains (1) or (2), to replace a deficiency in said component resulting from the pasteurization.

4. The method of claim 1, wherein the at least one non-cellular organic component contributes to the digestibility of the feed or the bioavailability of a nutrient component of the feed.

5. The method of claim 1, wherein the human breast milk in the feed of (a) comprises donor breast milk from a human female who is not the biological mother of the human infant.

6. The method of claim 1, wherein the at least one non-cellular organic component comprises an enzyme capable of digestion of a component of human breast milk, to improve absorption or bioavailability in a human infant.

7. (canceled)

8. The method of claim 1, wherein the at least one non-cellular organic component comprises a vitamin transporting protein.

9. (canceled)

10. The method of claim 1, wherein the at least one non-cellular organic component comprises an immunomodulatory protein.

11. (canceled)

12. The method of claim 1, wherein the at least one non-cellular organic component used for the supplementing is purified and isolated from human breast milk.

13. The method of claim 1, wherein the at least one non-cellular organic component used for the supplementing is provided by unpasteurized, never-frozen human breast milk from the biological mother of the human infant.

14. (canceled)

15. The method of claim 1, further comprising adding breast milk stem cells (BSCs) to the feed.

16. The method of claim 1, further comprising adding at least one live bacterium to the feed.

17. The method of claim 1, further comprising feeding the supplemented feed to a human infant.

18. The method of claim 17, wherein the human infant is a pre-term infant.

19. A milk-based food prepared according to the method of claim 1.

20. An infant feeding device containing a milk-based food of claim 19.

21. A device comprising:
(1) a milk chamber for receiving human breast milk;
(2) at least one reagent chamber; and
(3) at least one reaction chamber for mixing a sample of the human breast milk with at least one reagent from the at least one reagent chamber.

22. The device according to claim 21, further comprising:
(4) a detector to provide a quantitative indication of at least one reaction product(s) from the sample of the human breast milk and the reagent.

23. The device according to claim 20, further comprising at least one supplement chamber to hold at least one nutritional supplement suitable for addition to human breast milk

24. The device according to claim 23, wherein the at least one reagent chamber contains reagent(s) for measuring the quantity and/or activity of at least one non-cellular organic component of human milk; and the at least one supplement chamber contain(s) at least one nutritional supplement that comprises said at least one non-cellular organic component measurable with the reagent(s).

25. The device according to claim 24, further comprising an infant feeding device operably connected to the at least one reagent chamber to receive a measured amount of nutritional supplement from the at least one supplement chamber.

26. (canceled)
